(19) United States
(12) Patent Application Publication
(10) Pub. No.: US 2011/0193769 A1
(43) Pub. Date: Aug. 11, 2011

(54) LIQUID CRYSTAL DISPLAY DEVICE

(76) Inventors: Hiroyuki Ohgami, Osaka (JP); Yoshito Hashimoto, Osaka (JP); Yuichi Iyama, Osaka (JP)

(21) Appl. No.: 13/123,538

(22) PCT Filed: Oct. 6, 2009
(86) PCT No.: PCT/JP2009/005171

§ 371 Date: Apr. 11, 2011

(30) Foreign Application Priority Data
Oct. 9, 2008 (JP) 2008-263128

(51) Int. Cl. G09G 3/36

(52) U.S. Cl. 345/87

(57) ABSTRACT

A liquid crystal display device (100) according to the present invention includes: an active-matrix substrate (120) including pixel electrodes (124); a counter substrate (140) including a counter electrode (144); and a vertical alignment liquid crystal layer (160), which is interposed between the active-matrix substrate (120) and the counter substrate (140). The counter electrode (144) includes a number of divided counter electrodes (145). Each of the pixel electrodes (124) is associated with at least two of the divided counter electrodes that are arranged over the pixel electrode (145).

### TECHNICAL FIELD

The present invention relates to a liquid crystal display device.

### BACKGROUND ART

Liquid crystal displays (LCDs) have been used in not only TV sets with a big screen but also small display devices such as the monitor screen of a cellphone. TN (twisted nematic) mode LCDs, which would often be used in the past, achieved relatively narrow viewing angles, but LCDs of various other modes with wider viewing angles have recently been developed one after another. Examples of those wider viewing angle modes include IPS (in-plane switching) mode and VA (vertical alignment) mode. Among those wide viewing angle modes, the VA mode is adopted in a lot of LCDs because the VA mode would achieve a sufficiently high contrast ratio.

Known as a kind of VA mode LCD is an MVA (multi-domain vertical alignment) mode LCD in which multiple liquid crystal domains are defined within a single pixel region. In an MVA mode LCD, an alignment control structure is provided for at least one of the two substrates, which face each other with a vertical alignment liquid crystal layer interposed between them, so that the alignment control structure contacts with the liquid crystal layer. As the alignment control structure, a linear slit (opening) or a rib (projection) of an electrode may be used, thereby applying anchoring force to the liquid crystal layer from one or both sides thereof. In this manner, multiple (typically four) liquid crystal domains with multiple different alignment directions are defined, thereby attempting to improve the viewing angle characteristic.

Also known as another kind of VA mode LCD is a CPA (continuous pinwheel alignment) mode LCD. In a normal CPA mode LCD, its pixel electrodes have a highly symmetric shape and either an opening or a projection (which is sometimes called a “rivet”) is arranged on the surface of the counter substrate in contact with the liquid crystal layer so as to be aligned with the center of a liquid crystal domain. When a voltage is applied, an oblique electric field is generated by the counter electrode and the highly symmetric pixel electrode and induces radially tilting alignments of liquid crystal molecules. Also, with a rivet provided, the anchoring force produced on the slope of the rivet stabilizes the tilted alignments of the liquid crystal molecules. As the liquid crystal molecules are radially aligned within a single pixel in this manner, the viewing angle characteristic can be improved.

It is known that the display quality achieved by a VA mode LCD when the viewer is located right in front of the screen (which will be referred to herein as “when viewed straight on”) is significantly different from the one achieved when the viewer is located obliquely with respect to the screen (which will be referred to herein as “when viewed obliquely”), which is a problem with the VA mode LCD. Particularly when a grayscale tone is displayed, if adjustments are made so as to optimize the display performance when viewed straight on, then the display performance (including the hue and the gamma characteristic) achieved when viewed obliquely will be quite different from the one achieved when viewed straight on. The optic axis direction of a liquid crystal molecule is the major axis direction of that molecule. When a grayscale tone is displayed, the optic axis direction of a liquid crystal molecule is somewhat tilted with respect to the principal surface of the substrate. And if the viewing angle (or viewing direction) is changed in such a state so as to view the screen obliquely and parallel to the optic axis direction of the liquid crystal molecules, the resultant display performance will be totally different from the one achieved when viewed straight on.

Specifically, when viewed obliquely, the displayed image will look more whitish as a whole than when viewed straight on, which is called a “whitening” phenomenon. For example, if a person's face is displayed, the viewer will find that person's facial expressions displayed quite natural when viewing right in front of the screen. However, when viewing obliquely, he or she will sense that person's face look unnaturally white overall. In that case, subtle tones of the person's skin color may be lost and an overall whitish face may be displayed instead.

To minimize such a whitening phenomenon, multiple (typically two) subpixels may be formed by splitting a single pixel electrode into multiple (typically two) subpixel electrodes and setting the potentials at those subpixel electrodes to be different from each other. In such an LCD, the grayscale characteristic of each subpixel is controlled so as to prevent the display performance from deteriorating even when viewed obliquely from what is achieved when viewed straight on (see Patent Documents Nos. 1 to 3, for example).

Specifically, in the LCD disclosed in Patent Document No. 1, the two subpixel electrodes are connected to mutually different source bus lines by way of two different switching elements and are driven so as to have respectively different potentials. If the two subpixel electrodes have mutually different potentials in this manner, then two different voltages will be applied to respective portions of the liquid crystal layer that are associated with those two subpixels, thus making the transmittances of those subpixels different from each other. Consequently, the whitening phenomenon can be much less perceptible.

On the other hand, in the LCD disclosed in Patent Document No. 2, two different switching elements associated with the two subpixel electrodes are connected to mutually different gate bus lines. In the LCD disclosed in Patent Document No. 2, since the two gate bus lines are activated at mutually different points in time at least partially, the two subpixel electrodes are driven so as to have respectively different potentials.

Furthermore, the LCD disclosed in Patent Document No. 3 has two CS bus lines, each of which forms, along with an associated one of the two subpixel electrodes, a storage capacitor either directly or indirectly. By applying mutually different CS voltages to those two CS bus lines, the effective voltage applied to the liquid crystal layer will change. In this manner, the LCD of Patent Document No. 3 reduces the whitening phenomenon to an imperceptible level.

### CITATION LIST

### Patent Literature

Patent Document No. 1: Japanese Patent Application Laid-Open Publication No. 2006-209135
Patent Document No. 2: Japanese Patent Application Laid-Open Publication No. 2006-139288
Patent Document No. 3: Japanese Patent Application Laid-Open Publication No. 2004-62146

### SUMMARY OF INVENTION

### Technical Problem

In the LCD disclosed in Patent Document No. 1, two source bus lines need to be provided for each column of pixels, and therefore, the number of source bus lines to provide should be doubled. On the other hand, in the LCD disclosed in Patent Document No. 2, two gate bus lines need to be provided for each row of pixels, thus doubling the number of gate bus lines to provide. Furthermore, in both of the LCDs of Patent Document Nos. 1 and 2, a TFT should be provided for each subpixel electrode. For that reason, the aperture ratio of the overall display area in the LCDs of Patent Documents Nos. 1 and 2 becomes lower than usual.

Meanwhile, in the LCD disclosed in Patent Document No. 3, the difference in the voltage applied to the liquid crystal layer is smaller than the difference in CS voltage. Particularly in a situation where a TFT has a large gate-drain capacitance, even if the CS voltages are significantly different from each other, the difference in the effective voltage applied to the respective portions of the liquid crystal layer that are associated with the two subpixels is not so great, and therefore, the transmittances of those two subpixels are not sufficiently different from each other. In that case, even if they attempt to control the grayscale characteristics of the subpixels sufficiently, the power dissipation will just increase, and therefore, the whitening phenomenon cannot be reduced efficiently.

It is therefore an object of the present invention to provide a liquid crystal display device that can minimize such a decrease in the aperture ratio of the display area and that can reduce the whitening phenomenon efficiently.

### Solution to Problem

A liquid crystal display device according to the present invention includes: an active-matrix substrate including a number of pixel electrodes that are arranged in columns and rows so as to form a matrix pattern; a counter substrate including a counter electrode; and a vertical alignment liquid crystal layer, which is interposed between the active-matrix substrate and the counter substrate. The counter electrode includes a number of divided counter electrodes. Each of the pixel electrodes is associated with at least two of the divided counter electrodes that are arranged over the pixel electrode.

In one preferred embodiment, each of the divided counter electrodes runs in a row direction in which the rows are defined.

In another preferred embodiment, the divided counter electrodes include first and second divided counter electrodes. The second electrode is arranged adjacent to the first electrode. First and second counter electrode signals are supplied to the first and second divided counter electrodes, respectively. The second signal is different from the first signal.

In still another preferred embodiment, each of the divided counter electrodes runs straight in the row direction. In this particular preferred embodiment, one row of the pixel electrodes is associated with at least two of the divided counter electrodes that are arranged over that row of pixel electrodes.

In yet another preferred embodiment, each of the divided counter electrodes has a portion that is extended obliquely with respect to the row direction.

In a specific preferred embodiment, at least one of the divided counter electrodes runs zigzag in the row direction.

In a more specific preferred embodiment, one of any two adjacent ones of the divided counter electrodes is superimposed over a part of one particular row of the pixel electrodes. The other one of the two adjacent divided counter electrodes is superimposed over not only another part of that particular row of pixel electrodes but also a part of another row of pixel electrodes that is adjacent to that particular row.

In an alternative preferred embodiment, each of the divided counter electrodes runs zigzag in the row direction.

In another preferred embodiment, one of any two adjacent ones of the divided counter electrodes runs zigzag in the row direction. The other one of the two adjacent divided counter electrodes has a trunk portion that runs straight in the row direction and branch portions, which are extended from the trunk portion so as to run in two opposite directions and change the directions one column after another.

In still another preferred embodiment, each of the pixel electrodes has multiple unit portions. Each of the divided counter electrodes is arranged over at least one of the unit portions that at least one of the pixel electrodes that form each row has.

In this particular preferred embodiment, liquid crystal molecules in the liquid crystal layer are aligned symmetrically with respect to the center of each of the unit portions.

In a specific preferred embodiment, the surface of the counter substrate that contacts with the liquid crystal layer has openings or rivets, which are located right over the respective centers of the unit portions.

In another specific preferred embodiment, each of the unit portions has a fishbone structure.

In this particular preferred embodiment, the surface of the unit portions that contacts with the liquid crystal layer has ribs or slits, and the surface of the counter substrate that contacts with the liquid crystal layer also has ribs or slits.

In yet another preferred embodiment, the area of some of the divided counter electrodes, to which the first counter electrode signal is supplied, is different from that of some other one(s) of the divided counter electrodes, to which the second counter electrode signal is supplied.

In an alternative preferred embodiment, the area of some of the divided counter electrodes, to which the first counter electrode signal is supplied, is substantially equal to that of some other one(s) of the divided counter electrodes, to which the second counter electrode signal is supplied.

In yet another preferred embodiment, the liquid crystal display device further includes a first alignment sustaining layer, which is arranged between the pixel electrodes and the liquid crystal layer, and a second alignment sustaining layer, which is arranged between the counter electrode and the liquid crystal layer.

In yet another preferred embodiment, at least one of the active-matrix substrate and the counter substrate further includes an alignment layer. When no voltage is applied to the liquid crystal layer, liquid crystal molecules tilt with respect to a normal to the principal surface of the alignment layer.

### Advantageous Effects of Invention

The present invention provides a liquid crystal display device that can minimize a decrease in the aperture ratio of the display area and that can reduce the whitening phenomenon efficiently.

### BRIEF DESCRIPTION OF DRAWINGS

FIG. 1 is a schematic representation illustrating a first preferred embodiment of a liquid crystal display device according to the present invention.

FIG. 2 is a schematic plan view of the liquid crystal display device shown in FIG. 1.

FIG. 3 is a schematic representation illustrating how lines are arranged on the counter substrate of the liquid crystal display device shown in FIG. 1.

FIG. 4 is a graph showing how the V-T characteristic changes with a potential at the counter electrode.

FIG. 5 shows the waveforms of counter electrode signals applied to first and second counter electrodes.

FIG. 6 is a graph showing how the oblique transmittance changes with respect to the straight transmittance.

FIG. 7(a) is a schematic representation showing the optical transmittances of two different pixels and FIG. 7(b) is a schematic cross-sectional view thereof.

FIG. 8(a) is a schematic representation showing the optical transmittances of two different pixels and FIG. 8(b) is a schematic cross-sectional view thereof.

FIG. 9(a) is a schematic representation showing the optical transmittances of two different pixels and FIG. 9(b) is a schematic cross-sectional view thereof.

FIG. 10(a) is a schematic representation showing the optical transmittances of two different pixels and FIG. 10(b) is a schematic cross-sectional view thereof.

FIG. 11(a) is a schematic plan view illustrating a second preferred embodiment of a liquid crystal display device according to the present invention and FIG. 11(b) is a schematic cross-sectional view thereof.

FIG. 12 is a schematic representation illustrating an arrangement of counter electrodes in a liquid crystal display device as a third preferred embodiment of the present invention.

FIG. 13 is a schematic representation illustrating an alternative arrangement of counter electrodes in a modified example of the third preferred embodiment.

FIG. 14 is a schematic representation illustrating a fourth preferred embodiment of a liquid crystal display device according to the present invention.

FIG. 15 is a graph showing how the oblique transmittance changes with respect to the straight transmittance.

FIG. 16 is a schematic representation illustrating a fifth preferred embodiment of a liquid crystal display device according to the present invention.

FIG. 17 is a schematic representation illustrating a sixth preferred embodiment of a liquid crystal display device according to the present invention.

FIG. 18 is a graph showing how the oblique transmittance changes with respect to the straight transmittance.

FIG. 19 is a schematic representation illustrating a seventh preferred embodiment of a liquid crystal display device according to the present invention.

FIG. 20 is a schematic representation illustrating an arrangement of counter electrodes in a liquid crystal display device as an eighth preferred embodiment of the present invention.

FIG. 21 is a schematic representation illustrating a ninth preferred embodiment of a liquid crystal display device according to the present invention.

### DESCRIPTION OF EMBODIMENTS

Hereinafter, preferred embodiments of a liquid crystal display device according to the present invention will be described with reference to the accompanying drawings. It should be noted that the present invention is in no way limited to the specific preferred embodiments to be described below.

### Embodiment 1

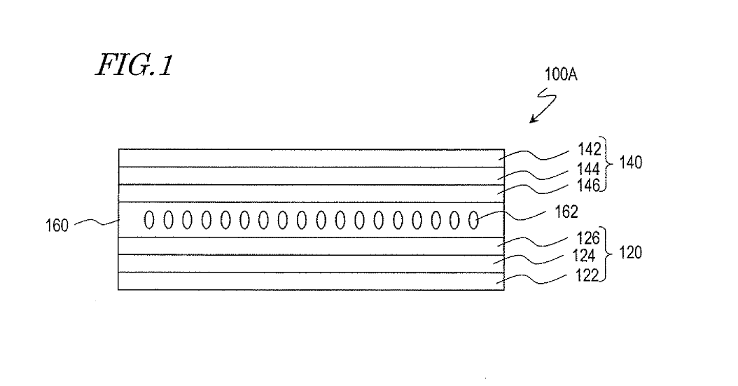

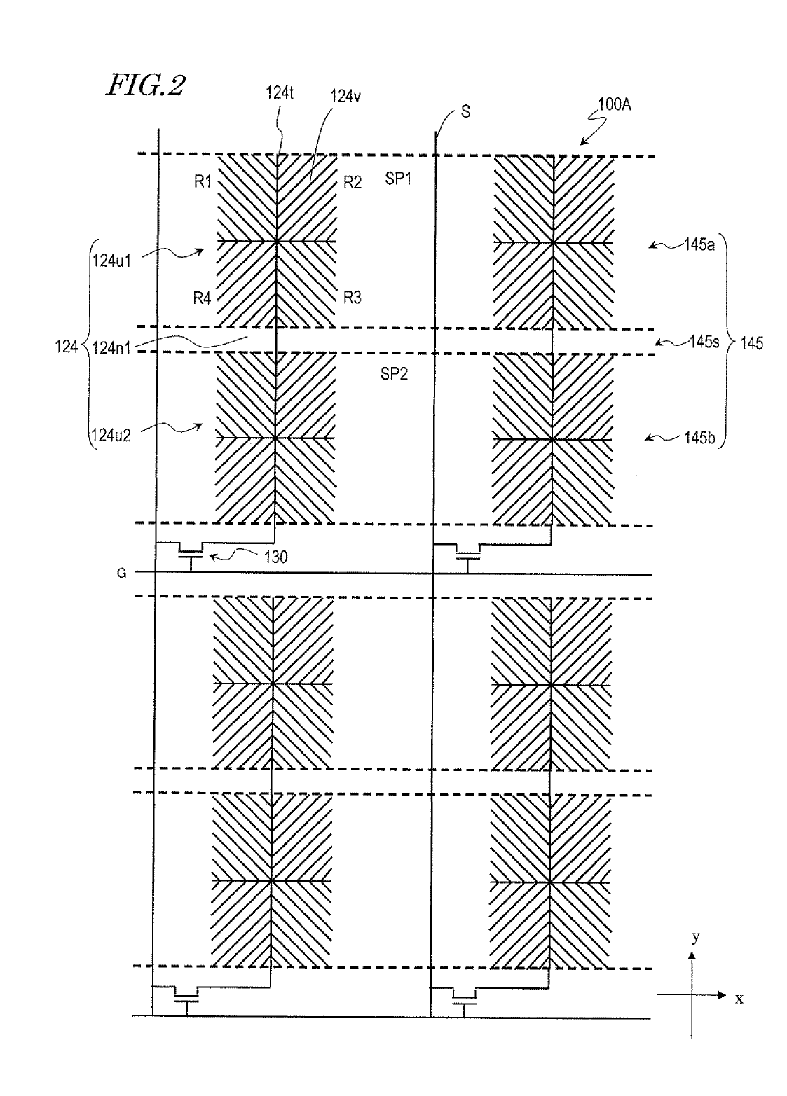

First of all, a First Specific Preferred Embodiment of a liquid crystal display device according to the present invention will be described. FIGS. 1 and 2A are respectively a schematic representation and a schematic plan view illustrating a liquid crystal display device 100A as a first preferred embodiment of the present invention.

The liquid crystal display device 100A includes an active-matrix substrate 120 with pixel electrodes 124 and an alignment layer 126 that have been stacked in this order on an insulating substrate 122, a counter substrate 140 with a counter electrode 144 and another alignment layer 146 that have also been stacked in this order on another insulating substrate 142, and a liquid crystal layer 160, which is interposed between the active-matrix substrate 120 and the counter substrate 140. Although not shown, two polarizers are provided for the active-matrix substrate 120 and the counter substrate 140, respectively, and are arranged so that their polarization axes satisfy the crossed Nicols relation. The liquid crystal layer 160 has a substantially uniform thickness.

In this liquid crystal display device 100A, a number of pixels are arranged in columns and rows so as to form a matrix pattern. For example, in a liquid crystal display device that conducts a color display operation using R (red), G (green) and B (blue) as the three primary colors, one color is represented by a set of R, G and B pixels. In this case, each pixel is defined by an associated one of the pixel electrodes 124.

This liquid crystal display device 100A operates in the VA mode. Thus, the alignment layers 126 and 146 are vertical alignment layers and the liquid crystal layer 160 is a vertical alignment liquid crystal layer. As used herein, the “vertical alignment liquid crystal layer” refers to a liquid crystal layer in which the axis of its liquid crystal molecules (which will be sometimes referred to herein as an “axial direction”) defines an angle of approximately 85 degrees or more with respect to the surface of the vertical alignment layers 126 and 146. The liquid crystal molecules have negative dielectric anisotropy. Using such liquid crystal molecules along with two polarizers that are arranged as crossed Nicols, this device conducts a display operation in a normally black mode. Specifically, in that mode, when no voltage is applied to the liquid crystal layer 160, the liquid crystal molecules 162 in the liquid crystal layer 160 are aligned substantially parallel to a normal to the principal surface of the alignment layers 126 and 146. On the other hand, when a voltage that is higher than a predetermined voltage is applied to the liquid crystal layer 160, the liquid crystal molecules 162 in the liquid crystal layer 160 are aligned substantially parallel to the principal surface of the alignment layers 126 and 146. In this example, each of the active-matrix substrate 120 and the counter substrate 140 has its alignment layer 126, 146. However, according to the present invention, at least one of the active-matrix substrate 120 and the counter substrate 140 needs to have its alignment layer 126 or 146. Nevertheless, in order to stabilize the alignments, it is still preferred that both of the active-matrix substrate 120 and the counter substrate 140 have their own alignment layer 126, 146.

FIG. 2 schematically illustrates some pixels of the liquid crystal display device 100A. Gate bus lines G run in the x direction, while source bus lines S run in the y direction. Also, a TFT 130 is arranged in the vicinity of each of the intersections between the gate bus lines G and the source bus lines S. The pixels illustrated in FIG. 2 are arranged in two columns and two rows.

Each of the pixel electrodes 124 includes two unit portions 124u1 and 124u2 and a linking portion 124n1. The unit portions 124u1 and 124u2 are arranged in the column direction (i.e., in the y direction). The linking portion 124n1 links these two unit portions 124u1 and 124u2 together. And the potential at one unit portion 124u1 is as high as the potential at the other unit portion 124u2. Although not all of them are illustrated in FIG. 2, each display area unit that represents one color in the liquid crystal display device 100A has six unit portions in total, which are arranged in two columns and three rows. That is to say, each row consists of two unit portions that are arranged in the x direction and each column consists of three unit portions that are arranged in the y direction.

These two unit portions 124u1 and 124u2 have the same shape. Specifically, the unit portion 124u1 includes a crossed axis portion 124t and striped portions 124v, which are extended from the axis portion 124t. Suppose the four regions defined by the crossed axis portion 124t are identified by R1 through R4, respectively, the horizontal direction on the display screen (i.e., on the paper) is the reference direction to determine the azimuth, and the counterclockwise direction is positive direction. That is to say, comparing the display screen to the face of a clock, the three o'clock direction corresponds to an azimuth of zero degrees and the counterclockwise direction is the positive direction. In that case, the striped portions 124v of the regions R1 and R3 run in two opposite directions that are defined by azimuths of 135 and 315 degrees, respectively. On the other hand, the striped portions 124v of the regions R2 and R4 run in two opposite directions that are defined by azimuths of 45 and 225 degrees, respectively. As can be seen, these two unit portions 124u1 and 124u2 have a fishbone structure. Also, each of these unit portions 124u1 and 124u2 measures 45 μm square and the linking portion 124n1 has a length of 5 μm. The width of the axis portion 124t and the width and the pitch of the striped portions 124v are 4 μm, 2.5 μm, and 5.0 μm, respectively.

In the liquid crystal display device 100A of this preferred embodiment, the counter electrode 144 is formed of a number of electrodes 145 that are separated from each other. Such separated electrodes will be referred to herein as “divided counter electrodes”.

Also, as can be seen easily from FIG. 2, in this liquid crystal display device 100A, each divided counter electrode 145 runs straight in the row direction. In the following description, such a divided counter electrode that runs straight will sometimes be referred to herein as “linear counter electrode”. A linear slit 145s has been cut between two adjacent linear counter electrodes 145. And those two linear counter electrodes 145 are arranged right over the pixel electrodes 124 that are arranged to form one row. Each linear counter electrode 145 has a width of 45 μm as measured in the y direction and each slit 145s has a width of 5 μm.

In this example, the two linear counter electrodes 145 that are respectively arranged over the unit portions 124u1 and 124u2 of one pixel electrode 124 will be identified herein by the reference numerals 145a and 145b and sometimes referred to herein as a “first linear counter electrode 145a” and a “second linear counter electrode 145b”, respectively. The first and second linear counter electrodes 145a and 145b are electrically independent of each other and supplied with mutually different counter electrode signals. Those signals applied to the first and second linear counter electrodes 145a and 145b will be referred to herein as a “first counter electrode signal” and a “second counter electrode signal”, respectively. Those first and second counter electrode signals may be either generated by an external circuit and input to this liquid crystal display device 100A through two COM terminals or generated by a driver.

Each pixel P defined by its associated pixel electrode 124 has two subpixels SP1 and SP2, which are defined by the superimposition of the first linear counter electrode 145a over the unit portion 124u1 and the superimposition of the first linear counter electrode 145b over the unit portion 124u2, respectively. Thus, in this liquid crystal display device 100A, each of these unit portions 124u1 and 124u2 functions as a subpixel electrode.

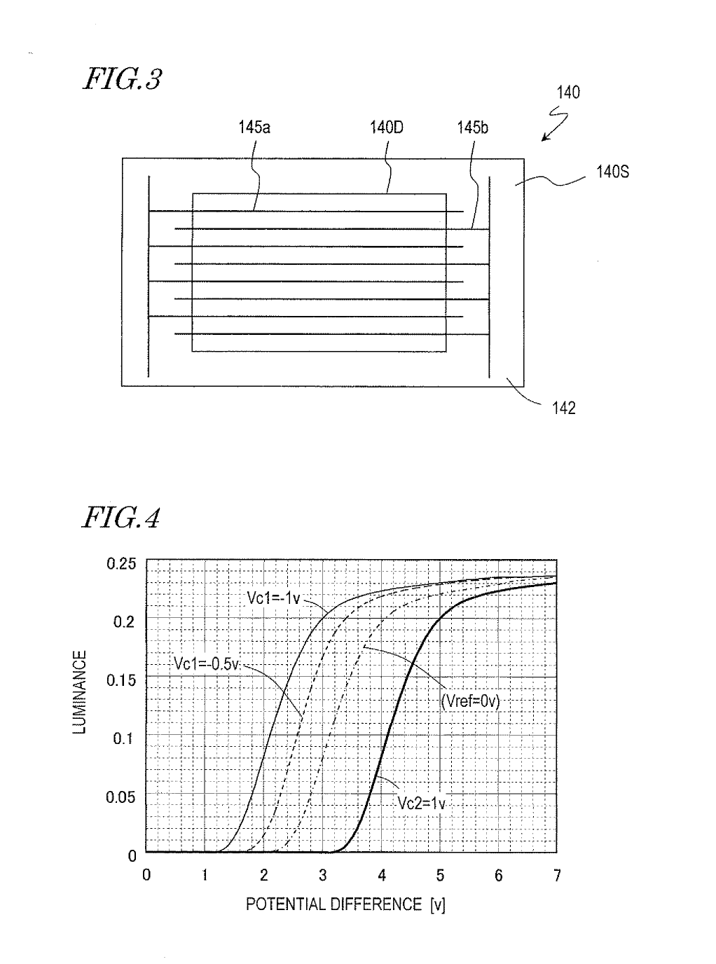

As shown in FIG. 3, the counter substrate 140 has a display area 140D and a frame area 140S, which surrounds the display area 140D. The first and second counter electrode signals are supplied to the linear counter electrodes 145a and 145b through two lines that are arranged in respective portions of the frame area 1405 on the left- and right-hand sides of the display area 140S. In this case, the linear counter electrodes 145 on odd-numbered rows are electrically connected together with one of those two lines and receive the first counter electrode signal, while the linear counter electrodes 145 on even-numbered rows are electrically connected together with the other line and receive the second counter electrode signal.

Now look at FIGS. 1 and 2 again. When a voltage is applied to the liquid crystal layer 160, the liquid crystal molecules 162 in the liquid crystal layer 160 are aligned parallel to the direction in which the striped portions 124v run. At that time, the fishbone structure of the unit portions 124u1 and 124u2 stabilizes the alignments of the liquid crystal molecules 162, thereby producing liquid crystal domains in those four regions R1 through R4.

In the following description, the alignment direction of liquid crystal molecules around the center of a liquid crystal domain will be referred to herein as a “reference alignment direction”. On the other hand, the azimuthal component of that reference alignment direction that points from the rear plane toward the front plane of the liquid crystal display device along the liquid crystal molecules major axis (i.e., the azimuthal component obtained by projecting the reference alignment direction onto the principal surface of one of the two alignment layers 126 and 146) will be referred to herein as a “reference alignment azimuth”. Each reference alignment azimuth characterizes its associated liquid crystal domain and has a dominant effect on the viewing angle characteristic of that liquid crystal domain. Specifically, the respective reference alignment directions of the liquid crystal domains (i.e., the regions R1 through R4) are defined to be four directions, any two of which have a difference that is substantially equal to an integral multiple of 90 degrees. More specifically, these four regions or liquid crystal domains R1 through R4 have reference alignment azimuths of 135, 45, 315 and 225 degrees, respectively. As a result, a symmetric viewing angle characteristic is realized.

As described above, a first counter electrode signal is applied to the first linear counter electrode 145a, and a second counter electrode signal, which is different from the first counter electrode signal, is applied to the second linear counter electrode 145b. Since the unit portions 124u1 and 124u2 of each pixel electrode 124 have an equivalent potential, the voltage applied to a portion of the liquid crystal layer 160 between the unit portion 124u1 and the first linear counter electrode 145a is different from the voltage applied to another portion of the liquid crystal layer 160 between the unit portion 124u2 and the second linear counter electrode 145b. And at a grayscale tone, the subpixel SP1 has a different transmittance from the subpixel SP2.

In this example, to avoid giving overly complicated description, the input signal is supposed to make the grayscale levels of all pixels equal to each other. For example, if the input signal is going to increase the grayscale level of every pixel to the maximum one, then the color white will be displayed on the entire screen. Also, if a voltage of 5 V is applied to the liquid crystal layer 160, then each pixel has a transmittance that is associated with the maximum grayscale level.

In order to reduce the whitening phenomenon, the liquid crystal display device 100A of this preferred embodiment regulates the potential at the counter electrode, not at the pixel electrodes. Now let us consider how high the potentials at the pixel electrodes 124 and at the first and second linear counter electrodes 145a and 145b should be with respect to the reference potential at the counter electrode. For example, if the voltage applied to the liquid crystal layer 160 is 5 V and if the potential at the pixel electrode 124 is higher than the potential at the counter electrode 144 and if the reference potential at the counter electrode 144 is 0 V, then the potential at the pixel electrodes 124 is 5 V. It should be noted that the reference potential at the counter electrode 144 is not always equal to the so-called “ground potential”.

In this liquid crystal display device 100A, the potential at the first linear counter electrode 145a is −1 V with respect to the reference potential and the potential at the second linear counter electrode 145b is +1 V with respect to the reference potential. In that case, the voltage applied to the liquid crystal layer 160 of the subpixel SP1 is 6 V and the voltage applied to the liquid crystal layer 160 of the subpixel SP2 is 4 V. Thus, the voltage applied to the liquid crystal layer 160 of the subpixel SP1 associated with the first linear counter electrode 145a is different from the one applied to that of the subpixel SP2 associated with the second linear counter electrode 145b.

It should be noted that the sum of the variations in the potentials at the first and second linear counter electrodes 145a and 145b with respect to the reference potential is substantially equal to zero. Also, the average of the transmittances of the subpixels SP1 and SP2 is substantially equal to that of the pixel when a reference voltage is applied to the counter electrode.

Hereinafter, it will be described with reference to FIG. 4 how the V-T characteristic changes with varying potentials at the counter electrode. In FIG. 4, the abscissa represents the potential difference (or its absolute value) between the potential at the pixel electrodes and the reference potential at the counter electrode, while the ordinate represents the intensity.

If the potential Vc of the counter electrode signal varies by +1 V, then the voltage applied to the liquid crystal layer changes by −1 V and the rising voltage of the V-T curve changes by +1 V. Conversely, if the potential Vc of the counter electrode signal varies by −1 V, then the voltage applied to the liquid crystal layer changes by +1 V and the rising voltage of the V-T curve changes by −1 V.

Likewise, if the potential of the counter electrode signal varies by 0.1 V, then the rising voltage of the V-T curve of the pixel increases or decreases by 0.1 V. Specifically, if the potential at the pixel electrodes 124 is positive and if the potential of the first counter electrode signal is −0.1 V with respect to the reference potential of the counter electrode, the rising voltage of the V-T curve of the pixel with respect to the first counter electrode signal is lower by 0.1 V than that of the V-T curve of the pixel with respect to the reference potential of the counter electrode. On the other hand, if the potential of the second counter electrode signal is +0.1 V with respect to the reference potential of the counter electrode, the rising voltage of the V-T curve of the pixel with respect to the second counter electrode signal is higher by 0.1 V than that of the V-T curve of the pixel with respect to the reference potential of the counter electrode. In this manner, if there multiple regions with mutually different counter electrode potentials, then those regions will have mutually different V-T curves, and therefore, the whitening phenomenon can be reduced. On top of that, since the difference in the voltage applied to the liquid crystal layer corresponds to the difference in the potential of the counter electrode signal, the whitening phenomenon can be reduced efficiently as well.

It should be noted that although the potential at the first linear counter electrode 145a is different from the one at the second linear counter electrode 145b, the average of the respective potentials of the first and second linear counter electrodes 145a and 145b is equal to the reference potential of the counter electrode. That is why as can be seen from FIG. 4, the average of the respective luminances of the subpixels SP1 and SP2 associated with the first and second linear counter electrodes 145a and 145b, of which the potentials have been varied by +1 V and −1 V with respect to the reference potential at the counter electrode, is substantially equal to the luminance of the pixel with respect to the counter electrode with the reference potential.

Optionally, the liquid crystal display device 100A may be driven by line inversion driving method. In that case, the write operation may be performed so that the pixel electrodes 124 and the counter electrode 144 have the relationship (high or low) of their potential levels inverted every row of pixels. Specifically, if the potential at the pixel electrodes 124 is higher than the one at the counter electrode 144 when a write operation is performed on an n^{th} row of pixels, then the potential at the pixel electrodes 124 is lower than the one at the counter electrode 144 when a write operation is performed on the next (n+1)^{th} row of pixels. In this manner, the line inversion drive may be performed on a pixel-by-pixel basis.

Alternatively, the write operation may also be performed so that the pixel electrodes 124 and the counter electrode 144 have the relationship (high or low) of their potential levels inverted in each and every one of the unit portions that are adjacent to each other in the row direction. Specifically, if the potential at the unit portion 124u1 is higher than the one at the linear counter electrode 145a when a write operation is performed on a pixel electrode 124, then the potential at the unit portion 124u2 is lower than the one at the linear counter electrode 145b. In this manner, the line inversion drive may be performed on a subpixel basis.

Also, this liquid crystal display device 100A performs a frame inversion drive. That is to say, the write operation is carried out so that the pixel electrodes 124 and the counter electrode 144 have the relationship (high or low) of their potential levels inverted every frame. For example, if the potential at the pixel electrodes 124 is higher than the one at the counter electrode 144 when a write operation is performed on the N^{th} frame, then the potential at the pixel electrodes 124 is lower than the one at the counter electrode 144 when a write operation is performed on the (N+1)^{th} frame.

Still alternatively, this liquid crystal display device 100A may even be driven by common inversion driving method. In that case, the potential at the counter electrode 144 changes with respect to the ground potential every horizontal scanning period. For example, if the potential on a source bus line is higher than the reference potential at the counter electrode in one horizontal scanning period for selecting one row of pixels, then the source bus line potential is lower than the reference potential at the counter electrode in the next horizontal scanning period for selecting the next row of pixels. Thus, the amplitude of the source bus line may be equal to or smaller than that of the reference potential at the counter electrode. For instance, both of the first and second counter electrode signals may change so that their polarity is opposite to that of the potential at a pixel electrode 124 being subjected to writing with respect to the ground potential. By adopting such common inversion driving, a line inversion drive can be carried out so that the voltage applied to the liquid crystal layer can be increased without increasing the variation in source bus line potential with respect to the ground potential. As a result, the power dissipation can be cut down.

For example, the potentials of the first and second counter electrode signals VC1 and VC2 may change every horizontal scanning period and the amplitude of the first counter electrode signal VC1 may be greater than that of the second counter electrode signal VC2 as shown in FIG. 5. Since the amplitude of the source bus line is equal to or smaller than that of the reference potential at the counter electrode as described above, the subpixel SP1 associated with the first counter electrode signal VC1 has a higher transmittance than the subpixel SP2 associated with the second counter electrode signal VC2.

For example, if the reference potential at the counter electrode has an amplitude of 5.4 V with respect to the ground potential, then the potentials at the first and second linear counter electrodes 145a and 145b have amplitudes of 6.4 V and 4.4 V, respectively, with respect to the ground potential. It should be noted that the feedthrough voltage is not taken into account in this example. Optionally, the potentials at those counter electrodes may also be controlled by adjusting the respective centers of amplitude of the first and second counter electrode signals.

If a signal that makes every pixel display the color white has been input, then the source bus line potential will have an amplitude of 0.4 V. In that case, a voltage of 6 V will be applied to a portion of the liquid crystal layer 160 between the first linear counter electrode 145a and the unit portion 124u1 and a voltage of 4 V will be applied to another portion of the liquid crystal layer 160 between the second linear counter electrode 145b and the unit portion 124u2. And the subpixel SP1 will have a higher transmittance than the subpixel SP2. If one of two given subpixels that has the higher transmittance is referred to herein as a “bright subpixel” and the other subpixel that has the lower transmittance as a “dark subpixel”, then the subpixels SP1 and SP2 are a bright subpixel and a dark subpixel, respectively. By reducing the amplitude of the counter electrode signal, the power dissipation can be cut down, and therefore, this liquid crystal display device 100A can be used particularly effectively in mobile electronic devices.

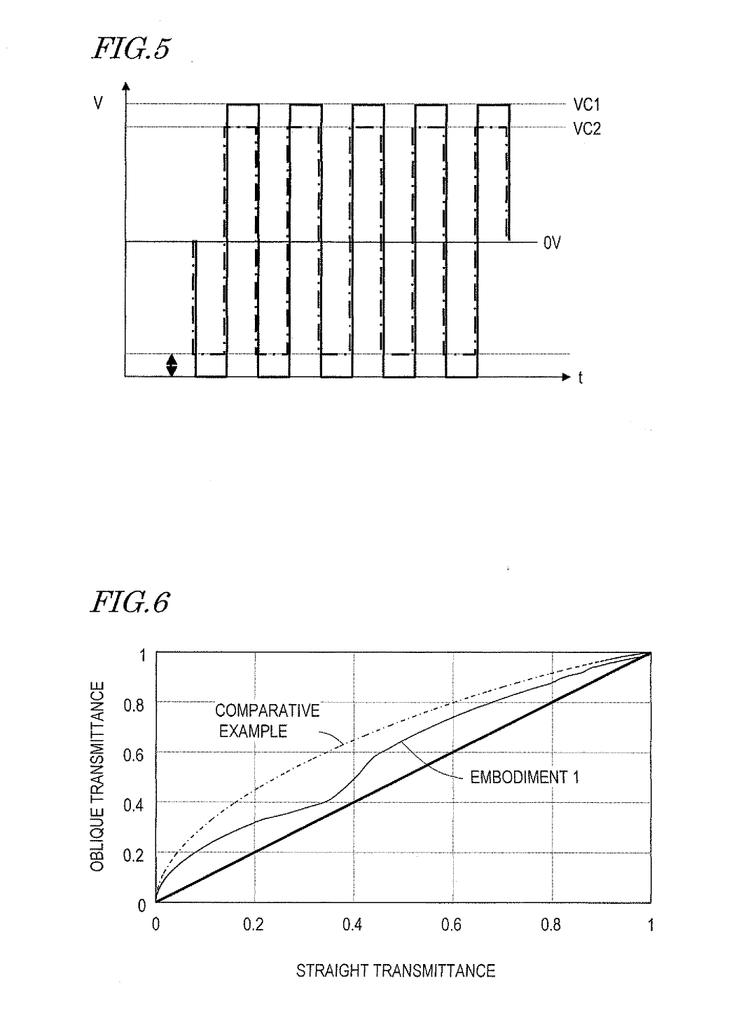

Hereinafter, advantages of the liquid crystal display device 100A of this preferred embodiment over a liquid crystal display device as a comparative example will be described with reference to FIG. 6, which is a graph showing how the ratio of the oblique transmittance to the straight transmittance changes. As used herein, the “straight transmittance” is obtained by normalizing the transmittance to be measured when the screen is viewed straight on, while the “oblique transmittance” is obtained by normalizing the transmittance to be measured when the screen is viewed obliquely at a viewing angle of 60 degrees. Ideally, the oblique transmittance should be proportional to the straight one as indicated by the bold line in FIG. 6. In that case, the transmittance measured in the oblique viewing direction will change in the same way as the one measured in the straight viewing direction.

The liquid crystal display device of this comparative example has quite the same configuration as the liquid crystal display device 100A of this preferred embodiment except that the potential is constant anywhere on its counter electrode. As can be seen from the graph shown in FIG. 6, when the liquid crystal display device of this comparative example displays a grayscale tone, its oblique transmittance is much higher than its straight transmittance, and therefore, when viewed obliquely, the screen will look far more whitish than when viewed straight on. That is to say, in the liquid crystal display device of this comparative example, the whitening phenomenon arises.

On the other hand, in the liquid crystal display device 100A of this preferred embodiment, the first and second linear counter electrodes 145a and 145b have mutually different potentials and the V-T characteristic of the subpixel SP1 is different from that of the subpixel SP2. In that case, the overall V-T characteristic of this liquid crystal display device 100A becomes the average of the two different V-T characteristics of those subpixels SP1 and SP2. Consequently, the transmittance to be measured in the oblique viewing direction decreases at grayscale tones, and therefore, the whitening phenomenon can be reduced significantly.

It is preferred that the polymer sustained alignment technology (which will be referred to herein as a “PSA technology”) be applied to this liquid crystal display device 100A. According to the PSA technology, a small amount of polymerizable compound (which may be a photopolymerizable monomer, for example) is irradiated with an active energy line (such an ultraviolet ray) with a voltage to a liquid crystal layer including that polymerizable compound, thereby producing a polymer that is used to control the pretilt direction of the liquid crystal molecules. With the PSA technology adopted, the response speed can be increased. The PSA technology is disclosed in Japanese Patent Application Laid-Open Publications Nos. 2002-357830 and 2003-149647, which are hereby incorporated by reference.

With the PSA technology adopted, the liquid crystal display device 100A includes an alignment sustaining layer (not shown), which is arranged between each of the alignment layers 126 and 146 and the liquid crystal layer 160 separately from the alignment layers 126 and 146. Those alignment sustaining layers keep the liquid crystal molecules 162 slightly tilted with respect to a normal to the principal surface of the alignment layers 126 and 146, thus increasing the response speed of the liquid crystal molecules. That tilt angle may be 2 degrees, for example.

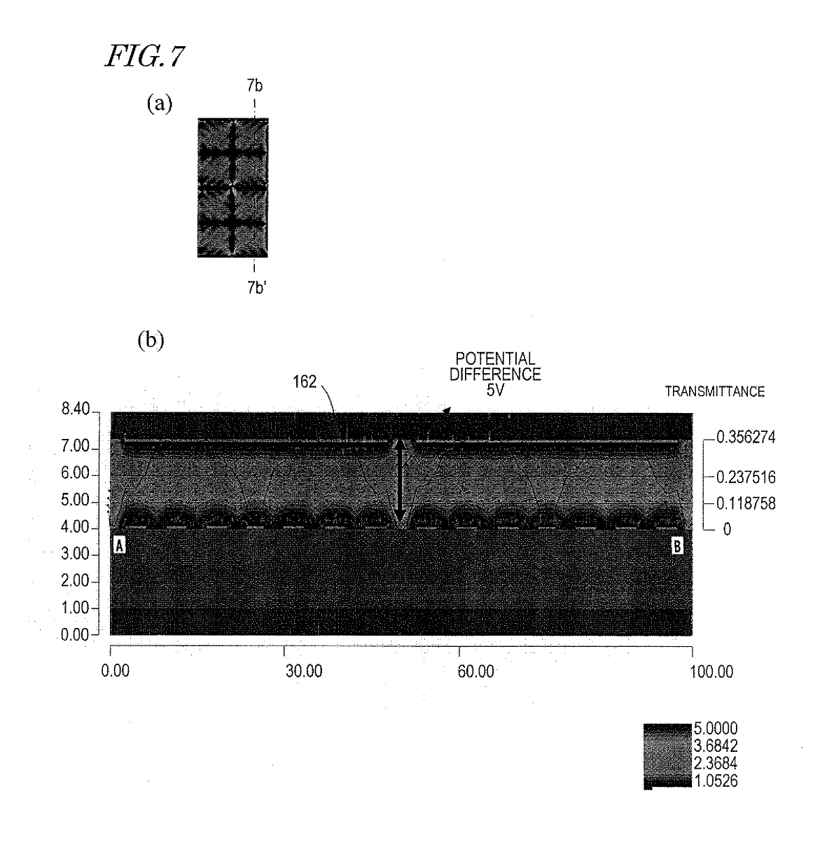

Hereinafter, it will be described with reference to FIGS. 7 through 10 what advantages are achieved by the alignment sustaining layer. Each of FIGS. 7(a), 8(a), 9(a) and 10(a) is a schematic representation showing the optical transmittances of two pixels in one unit portion. In each of FIGS. 7(a), 8(a), 9(a) and 10(a), the upper portion represents a pixel that is located under the first linear counter electrode, while the lower portion represents a pixel that is located under the second linear counter electrode. FIGS. 7(b), 8(b), 9(b) and 10(b) are schematic cross-sectional views as viewed on the planes 7b-7b′, 8b-8b′, 9b-9b′ and 10b-10b′ shown in FIGS. 7(a), 8(a), 9(a) and 10(a), respectively. FIGS. 7(b), 8(b), 9(b) and 10(b) also show the alignment direction of the liquid crystal molecules and the transmittance as well.

In FIG. 7, both of the first and second linear counter electrodes have the same potential as the reference potential of the counter electrode. In FIG. 7, the potentials at the first and second linear counter electrodes are indicated as “0 V” with respect to the reference potential of the counter electrode. In addition, in FIG. 7, the potentials at the pixel electrodes are indicated as “5 V” with respect to the reference potential of the counter electrode. That is to say, a voltage of 5 V is applied to the liquid crystal layer 160.

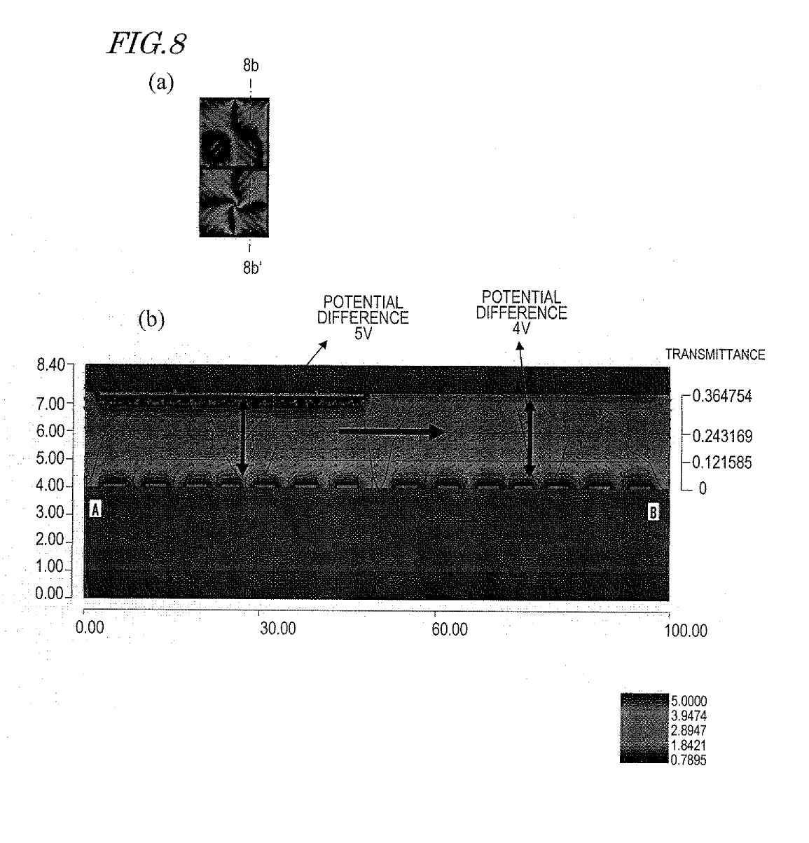

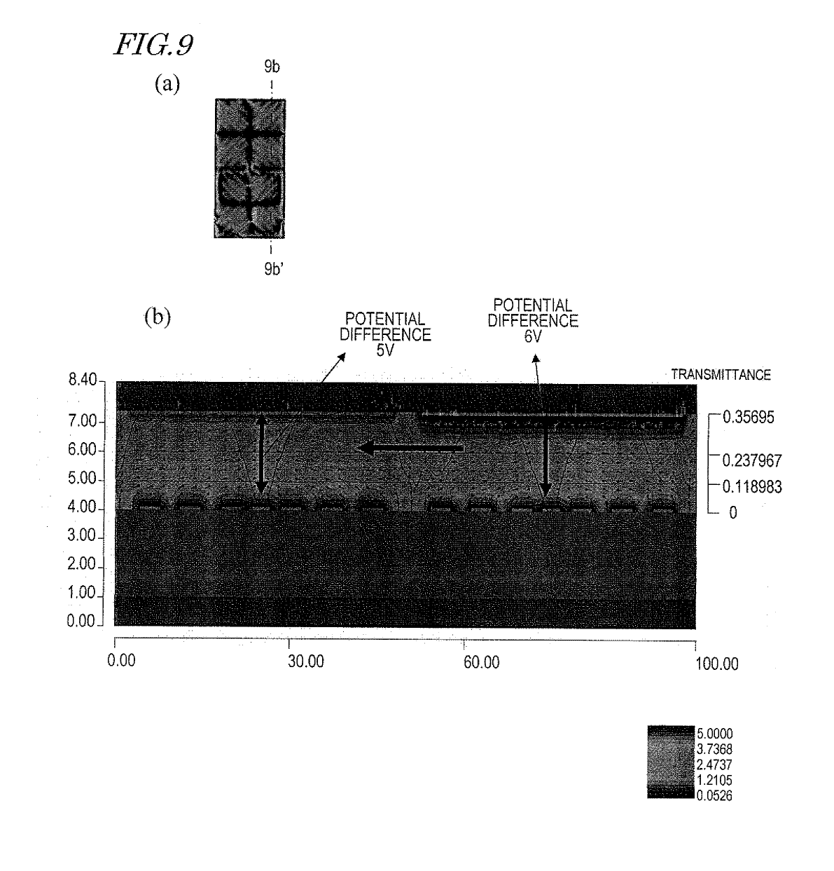

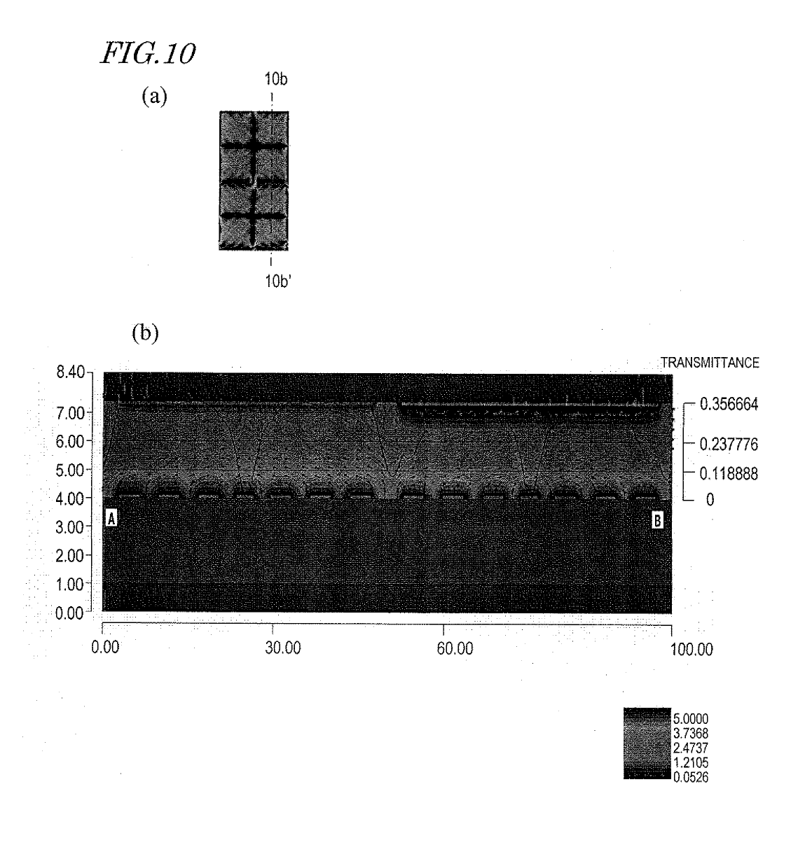

In the same way, in FIG. 8, the potentials at the first and second linear counter electrodes are indicated as “0 V” and “+1 V”, respectively, with respect to the reference potential of the counter electrode. In FIG. 9, the potentials at the first and second linear counter electrodes are indicated as “0 V” and “−1 V”, respectively, with respect to the reference potential of the counter electrode. Furthermore, in each of FIGS. 8, 9 and 10, the potentials at the pixel electrodes are indicated as “5 V” with respect to the reference potential of the counter electrode. It should be noted that although no alignment sustaining layers are provided in FIGS. 7, 8 and 9, alignment sustaining layers are provided in FIG. 10.

As shown in FIG. 7, if the first and second linear counter electrodes have an equal potential, stabilized alignments are realized. On the other hand, if the counter electrodes have mutually different potentials and if two different voltages are applied to two adjacent liquid crystal regions as shown in FIG. 8, then the alignments of the liquid crystal molecules are affected by that difference in applied voltage and will lose their stability. Among other things, the liquid crystal molecules 162 are subjected to such an anchoring force that causes them to be aligned parallel to equipotential curves. As a result, some of the liquid crystal molecules 162 in a region of the liquid crystal layer 160 to which a relatively high voltage is applied will be aligned so as to face toward a region with a relatively low applied voltage. Consequently, the liquid crystal molecules 162 in the latter region of the liquid crystal layer 160 with the higher applied voltage will have their alignment disturbed much more significantly than the liquid crystal molecules 162 in the former region with the lower applied voltage.

In the same way, if the counter electrodes have mutually different potentials and if two different voltages are applied to two adjacent liquid crystal regions as shown in FIG. 9, then the alignments of the liquid crystal molecules are affected by that difference in applied voltage and will lose their stability. Among other things, some of the liquid crystal molecules 162 in a region of the liquid crystal layer 160 to which a relatively high voltage is applied will be aligned so as to face toward a region with a relatively low applied voltage. Consequently, the liquid crystal molecules 162 in the latter region of the liquid crystal layer 160 with the higher applied voltage will have their alignment disturbed much more significantly than the liquid crystal molecules 162 in the former region with the lower applied voltage. However, if alignment sustaining layers are provided as shown in FIG. 10 by adopting the PSA technology, the alignments of the liquid crystal molecules 162 (particularly those located around the center of the unit portion 124u) are stabilized and the disturbance in alignment can be minimized, even though the counter electrodes have multiple different potentials.

This liquid crystal display device 100A may be fabricated by performing the following process, for example. First of all, gate bus lines, CS bus lines, and source bus lines (none of which are shown) are formed on an insulating substrate 122. After that, a conductive material is deposited thereon and patterned, thereby forming pixel electrodes 124. The fishbone structure of the pixel electrodes 124 can be defined by patterning. Thereafter, an alignment layer 126 is deposited over the pixel electrodes 124. In this manner, an active-matrix substrate 120 is obtained.

Next, a color filter layer (not shown) is formed on another insulating substrate 142. After that, a conductive material is deposited thereon and patterned, thereby forming a counter electrode 144. In this process step, the linear counter electrodes of the counter electrode 144 may be formed by patterning. Thereafter, another alignment layer 146 is deposited over the counter electrode 144. In this manner, a counter substrate 140 is obtained. And then a liquid crystal layer 160 is formed between the active-matrix substrate 120 and the counter substrate 140.

If the PSA technology is adopted, a polymerizable compound is added to the liquid crystal material that makes the liquid crystal layer 160. That polymerizable compound in the liquid crystal layer 160 is polymerized by being irradiated with light with a voltage applied between the pixel electrodes 124 and the counter electrode 144. Specifically, with a voltage of 10 V always applied to the gate bus line, a voltage with a predetermined rectangular wave is applied to a source bus line. The potential of the rectangular wave applied to the source bus line is normally applied to conduct a white display operation but could be varied according to the pretilt direction of the liquid crystal molecules 162. Strictly speaking, the pretilt direction of the liquid crystal molecules 162 changes with the lamp illuminance, wavelength and duration to adopt in the polymerization process, the alignment layer material to use (which is typically polyimide), the liquid crystal material, and other factors. With a DC voltage of 10 V constantly applied to the gate bus line, an AC voltage of 10 V is applied to the source bus line at a frequency of 60 Hz. By producing polymerization in this manner, two alignment sustaining layers are formed between the active-matrix substrate 120 and the liquid crystal layer 160 and between the counter substrate 140 and the liquid crystal layer 160. With those alignment sustaining layers provided, even if two adjacent linear counter electrodes 145 have mutually different potentials, the alignments of the liquid crystal molecules 162 can still be stabilized.

In the foregoing description of the first preferred embodiment of the present invention, the amplitude of the first counter electrode signal is supposed to be greater than that of the second counter electrode signal, and the absolute value of the voltage of the first counter electrode signal is supposed to be greater than that of the voltage of the second counter electrode signal. However, this is just an example and the present invention is in no way limited to that specific preferred embodiment. Alternatively, the amplitude of the first counter electrode signal may be equal to that of the second counter electrode signal and the first and second counter electrode signals may have the relationship (high or low) of their the absolute values of the voltages inverted every horizontal scanning period.

Also, in the foregoing description, each of the first and second linear counter electrodes 145a and 145b is supposed to run horizontally from one side of the frame area 140S to the other across the display area 140D as shown in FIG. 5. However, the present invention is in no way limited to that specific preferred embodiment. Alternatively, both of the first and second linear counter electrodes 145a and 145b may run from both sides of the frame area 140S across the display area 140D.

### Embodiment 2

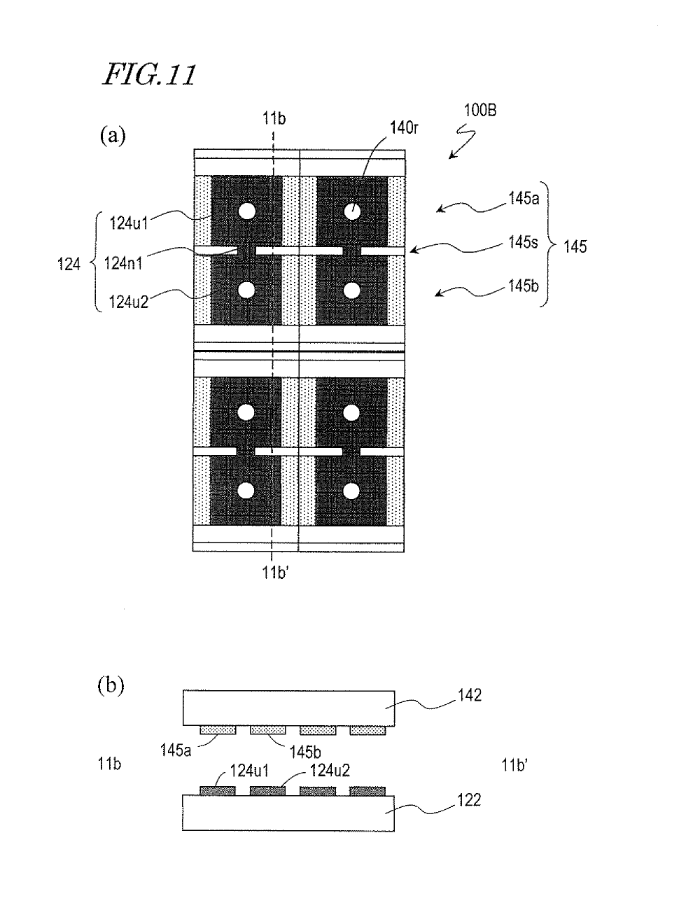

Hereinafter, another preferred embodiment of a liquid crystal display device according to the present invention will be described with reference to FIG. 11. A liquid crystal display device 100B as a second preferred embodiment of the present invention has the same configuration as its counterpart of the first preferred embodiment that has already been described with reference to FIGS. 1 and 2 except that this liquid crystal display device 100B operates in the CPA mode. Thus, description of their common features will be omitted herein to avoid redundancies.

FIGS. 11(a) and 11(b) are respectively a schematic plan view and a schematic cross-sectional view illustrating the liquid crystal display device 100B. FIG. 11(b) illustrates a cross section as viewed on the plane 11b-11b′ shown in FIG. 11(a). It should be noted that the alignment layers are not illustrated in FIG. 11(b).

In the liquid crystal display device 100B, each pixel electrode 124 includes two unit portions 124u1 and 124u2 and a linking portion 124n1 that connects the unit portions 124u1 and 124u2 together. In this preferred embodiment, the potential at the unit portion 124u1 is equal to the one at the unit portion 124u2. The unit portions 124u1 and 124u2 have a highly symmetric shape (e.g., rectangular in this example). The unit portions 124u1 and 124u2 have measurements of 59×58 μm, the linking portion has a width of 10 μm, and the gap between two adjacent unit portions is 8 μm.

In the liquid crystal display device 100B of this preferred embodiment, the counter electrode 144 also has multiple divided linear counter electrodes 145, and a slit 145s has been cut between two adjacent linear counter electrodes 145. The slit has a width of 5 μm. In addition, circular openings 140r have also been cut through the surface of the counter substrate 140 so as to contact with the liquid crystal layer 160 right over or under the respective centers of the unit portions 124u1 and 124u2.

In this example, the two linear counter electrodes 145 that are respectively arranged over the unit portions 124u1 and 124u2 of one pixel electrode 124 will be identified herein by the reference numerals 145a and 145b, respectively. The first and second linear counter electrodes 145a and 145b are electrically independent of each other and supplied with mutually different counter electrode signals. A first counter electrode signal and a second counter electrode signal, which has a different potential from the first counter electrode signal, are applied to the first and second linear counter electrodes 145a and 145b, respectively. When a voltage is applied to the liquid crystal layer 160, an oblique electric field is generated due to the respective shapes of the openings 140r and the unit portions 124u1 and 124u2. As a result, the liquid crystal molecules 162 in the liquid crystal layer 160 are radially aligned around the axis that is defined by the center of the unit portions 124u.

As in the liquid crystal display device 100A, by making the counter electrode signals have mutually different potentials, each pair of pixels can also have different transmittances and the whitening phenomenon can also be reduced significantly in this liquid crystal display device 100B, too. Likewise, the PSA technology described above is also applicable to this liquid crystal display device 100B as well as in the liquid crystal display device 100A described above. In that case, the response speed can be increased and the alignments of the liquid crystal molecules 162 can also be stabilized.

This liquid crystal display device 100B may be fabricated by performing the following process, for example. First of all, gate bus lines, CS bus lines, and source bus lines are formed on an insulating substrate 122. After that, a conductive material is deposited thereon and patterned, thereby forming pixel electrodes 124. In this manner, an active-matrix substrate 120 is obtained.

Next, a color filter layer is formed on another insulating substrate 142. After that, a conductive material is deposited thereon and patterned, thereby forming a counter electrode 144. In this process step, openings 140r are also cut. In this manner, a counter substrate 140 is obtained. And then the active-matrix substrate 120 and the counter substrate 140 are bonded together, and a liquid crystal layer 160 is formed between them.

If the PSA technology is adopted, a polymerizable compound is added to the liquid crystal material that makes the liquid crystal layer 160. That polymerizable compound in the liquid crystal layer 160 is polymerized by being irradiated with light with a voltage applied between the pixel electrodes 124 and the counter electrode 144. Specifically, with a voltage of 10 V always applied to the gate bus line, a voltage with a predetermined rectangular wave is applied to a source bus line. The potential of the rectangular wave applied to the source bus line is normally applied to conduct a white display operation but could be varied according to the pretilt direction of the liquid crystal molecules 162. Strictly speaking, the pretilt direction of the liquid crystal molecules 162 changes with the lamp illuminance, wavelength and duration to adopt in the polymerization process, the alignment layer material to use (which is typically polyimide), the liquid crystal material, and other factors. With a DC voltage of 10 V constantly applied to the gate bus line, an AC voltage of 10 V is applied to the source bus line at a frequency of 60 Hz. By producing polymerization in this manner, two alignment sustaining layers are formed between the active-matrix substrate 120 and the liquid crystal layer 160 and between the counter substrate 140 and the liquid crystal layer 160.

In the preferred embodiment described above, the unit portions 124u are supposed to be rectangular. However, the present invention is in no way limited to that specific preferred embodiment. Alternatively, the unit portions 124u may also have a substantially circular shape, a substantially elliptical shape, a substantially square or rectangular shape, or a substantially rectangular shape with rounded corners.

Also, in the preferred embodiment described above, openings 140r are cut through the counter substrate 140 so as to contact with the liquid crystal layer 160 right over or under the unit portions 124u1 and 124u2 of each pixel electrode 124. However, the present invention is in no way limited to that specific preferred embodiment. Alternatively, rivets may also be arranged on the counter substrate 140 so as to contact with the liquid crystal layer 160 right over or under the respective centers of the unit portions 124u1 and 124u2 of each pixel electrode 124.

### Embodiment 3

In the liquid crystal display devices 100A and 100B described above, the divided counter electrodes 145 are supposed to run straight in the row direction. However, the present invention is in no way limited to those specific preferred embodiments. Optionally, each of those divided counter electrodes 145 may have a portion that is extended obliquely with respect to the row direction.

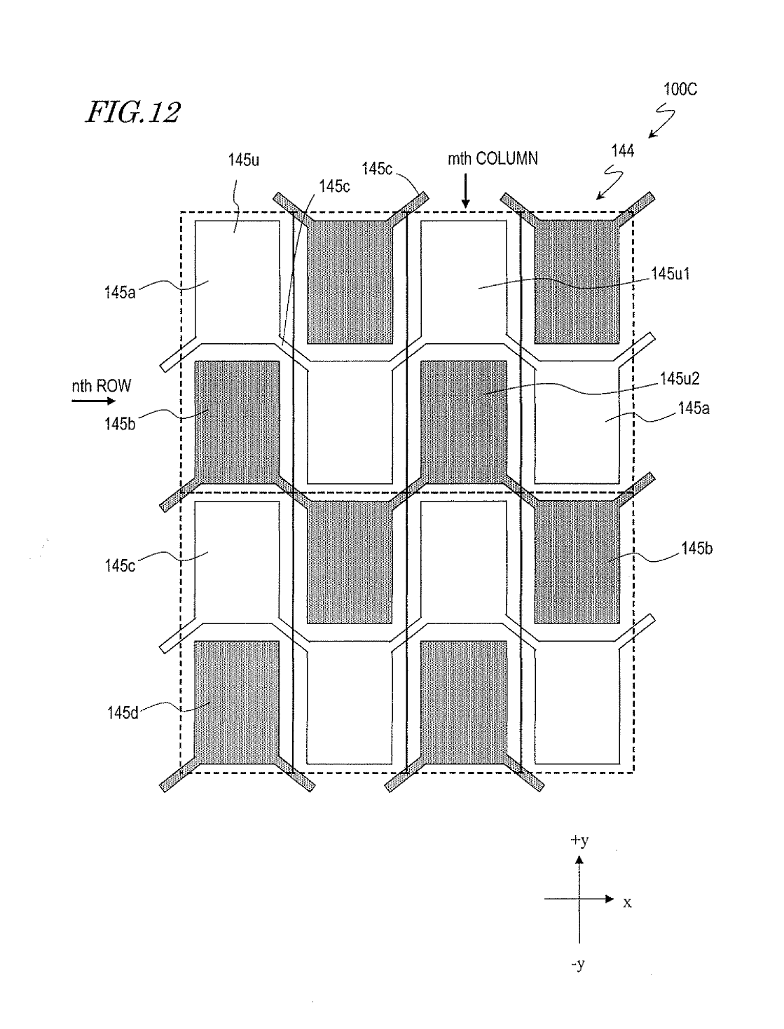

Hereinafter, a third preferred embodiment of a liquid crystal display device according to the present invention will be described with reference to FIG. 12. The liquid crystal display device 100C of this preferred embodiment has the same configuration as the liquid crystal display devices 100A and 100B described above except that the divided counter electrodes 145 of this liquid crystal display device 100C have a different shape from theirs. And description of their common features will be omitted herein to avoid redundancies. In FIG. 12, illustrated is only a portion of the counter electrode 144 that faces a matrix of pixels that are arranged in two rows and four columns.

In this liquid crystal display device 100C, each divided counter electrode 145 has portions that are extended obliquely with respect to the row direction, and runs zigzag in the row direction. Such a counter electrode 144 may be formed by patterning a conductive layer. In the following description, such a divided counter electrode that runs zigzag will sometimes be referred to herein as a “zigzag counter electrode”. In each zigzag counter electrode 145, if one portion thereof is arranged at a column over its associated unit portion 124u on one of two adjacent rows of the unit portions 124u that are arranged in matrix, another portion thereof will be arranged at the next column over its associated unit portion 124u on the other one of the two adjacent rows. And each portion of the zigzag counter electrode 145 that is laid over its associated unit portion 124u changes its rows one row to the other every column. Each of such portions has the same rectangular shape and almost the same measurements as its associated unit portion 124u. In the following description, such a portion will sometimes be referred to herein as a “counter electrode portion 145u”. Those counter electrode portions 145u are arranged in a matrix pattern and two counter electrode portions 145u face each single pixel electrode 124.

In this liquid crystal display device 100C, each counter electrode portion 145u of the counter electrode 144 is provided for one of two unit portions 124u of its associated pixel electrode 124. However, the counter electrode portion 145u is electrically connected to neither a counter electrode portion 145u that is adjacent to itself in the column direction nor a counter electrode portion 145u that is adjacent to itself in the row direction, but is electrically connected to a counter electrode portion 145u that is diagonally adjacent to itself with a connecting portion 145c. That is why if at one column, the zigzag counter electrode 145 has a counter electrode portion 145u on one of two adjacent rows of the counter electrode portions 145u that are arranged in matrix, the zigzag counter electrode 145 will have a counter electrode portion 145u on the other one of the two rows at the next column. The connecting portion 145c is a linear one to connect together two diagonally adjacent counter electrode portions 145u in the shortest distance and may have a width of 5 μm, for example. Likewise, the gap between one connecting portion 145c and two counter electrode portions 145u that do not contact with that connecting portion 145c is also 5 μm. In the following description, zigzag counter electrodes 145 that are respectively arranged over the unit portions 124u1 and 124u2 of a pixel electrode 124 located at the intersection between the n^{th} row and the m^{th} column will sometimes be identified herein by the reference numerals 145a and 145b, respectively. The zigzag counter electrode 145a is adjacent to the zigzag counter electrode 145b.

Look at any counter electrode portion 145u on the m^{th} column, and you can see that that counter electrode portion 145u is electrically connected to two counter electrode portions 145u that are diagonally adjacent to it in the −y direction (i.e., downward in the column direction) among the four diagonally adjacent counter electrode portions 145u in the column direction. Meanwhile, look at any counter electrode portion 145u on the (m+1)^{th} column, and you can see that that counter electrode portion 145u is electrically connected to two counter electrode portions 145u that are diagonally adjacent to it in the +y direction (i.e., upward in the column direction) among the four diagonally adjacent counter electrode portions 145u in the column direction.

Now let us look at the divided counter electrodes 145 of the counter electrode 144 in the liquid crystal display devices 100A and 100B shown in FIGS. 2 and 11 from a different angle. Even in those liquid crystal display devices 100A and 100B, each divided counter electrode 145 could be regarded as having a number of counter electrode portions that are provided for the unit portions of the pixel electrodes 124. And each pair of counter electrode portions that are adjacent to each other in the row direction could be regarded as being electrically connected together with a connecting portion that is as wide as those counter electrode portions.

Hereinafter, the liquid crystal display device 1000 of this preferred embodiment will be described in comparison with the liquid crystal display devices 100A and 100B shown in FIGS. 2 and 11.

First of all, consider their counter electrode portions 145u. In any of the liquid crystal display devices 100A, 100E and 1000, any two counter electrode portions 145u that are adjacent to each other in the column direction are separated from each other. In the liquid crystal display devices 100A and 100B, each counter electrode portion is electrically connected to two counter electrode portions that are adjacent to itself in the row direction. On the other hand, in the liquid crystal display device 100C, each counter electrode portion 145u is electrically connected to two diagonally adjacent counter electrode portions 145u. And in any of the liquid crystal display devices 100A, 100B and 100C, their counter electrode portions 145u that are arranged in matrix are electrically connected together from one end through the other end of the matrix in the row direction by passing through any number of columns and each of the divided counter electrodes 145 of the counter electrode 144 runs in the row direction.

Next, consider adjacent divided counter electrodes 145. In the liquid crystal display devices 100A and 100B, any two adjacent linear counter electrodes 145a and 145b are superimposed over all unit portions 124u of the pixel electrodes 124 on one particular row. On the other hand, in the liquid crystal display device 100C, all of the unit portions 124u, arranged under the zigzag counter electrode 145a, belong to the pixel electrodes 124 on one particular row. But the unit portions 124u, arranged under the zigzag counter electrode 145b, belong to not only the pixel electrodes 124 on that particular row but also the pixel electrodes 124 on another row that is adjacent to that particular row.

Next, consider the unit portions 124u belonging to the pixel electrodes 124 on one row. In the liquid crystal display devices 100A and 100B, all of the unit portions 124u belonging to the pixel electrodes 124 on one row are arranged under their associated two linear counter electrodes 145. In the liquid crystal display device 100C, on the other hand, all of the unit portions 124u belonging to the pixel electrodes 124 on one row are arranged under their associated three zigzag counter electrodes 145.

Furthermore, in the liquid crystal display devices 100A and 100B, if bright and dark subpixels are defined alternately with respect to each linear divided counter electrode 145a, 145b, then those bright subpixels will be arranged in line in the column direction, so will the dark subpixels. That is why even if every pixel displayed the same grayscale, a striped bright and dark pattern could be sensed and the display quality could decline. In the liquid crystal display device 100C, on the other hand, each divided counter electrode 145 has a zigzag shape, two different counter electrode signals are supplied to any two counter electrode portions 145u that are adjacent to each other in the row or column direction, but equivalent counter electrode signals are supplied to any two counter electrode portions 145u that are diagonally adjacent to each other. As a result, the dot inversion can get done easily on a subpixel basis and the decline in display quality can be minimized.

As described above, each counter electrode portion 145u of the counter electrode 144 is provided for the unit portion 124u of its associated pixel electrodes 124. That is why if the liquid crystal display device 100C operates in the CPA mode, an oblique electric field will be generated from the edges of each counter electrode portion 145u. For that reason, the center of each counter electrode portion 145u is ideally aligned with that of its associated unit portion 124u and the measurements of each counter electrode portion 145u are preferably greater than those of its associated unit portion 124u. However, even if the measurements of each counter electrode portion 145u are substantially equal to those of its associated unit portion 124u, the alignments will lose stability only around the edges of the subpixel and the center portion of the subpixel, which would determine the transmittance, will be hardly affected.

Suppose every pixel of the liquid crystal display device 100C displays white, the unit portion 124u of every pixel electrode 124 has a potential of 0.4 V, the first counter electrode signal has a potential of 6.4 V, and the second counter electrode signal has a potential of 4.4 V. In that case, a voltage of 6 V will be applied to the liquid crystal layer 160 of a subpixel SP1, which is defined by one unit portion 124u of each pixel electrode 124 and its associated counter electrode portion 145u to which the first counter electrode signal is applied. A voltage of 4 V will be applied to the liquid crystal layer 160 of a subpixel SP2, which is defined by the other unit portion 124u of that pixel electrode 124 and its associated counter electrode portion 145u to which the second counter electrode signal is applied. And the subpixels SP1 and SP2 turn into a bright subpixel and a dark subpixel, respectively. In this manner, the subpixel defined by the superimposition of the zigzag counter electrode 145a over one unit portion 124u of each pixel electrode 124 becomes a bright subpixel, while the subpixel defined by the superimposition of the zigzag counter electrode 145b over the other unit portion 124u of that pixel electrode 124 becomes a dark subpixel.

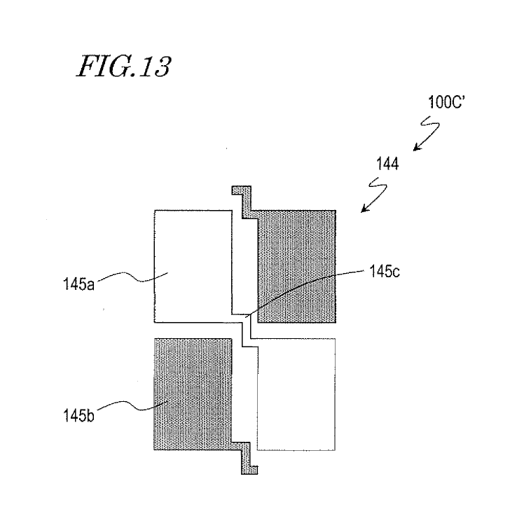

In the preferred embodiment described above, each connecting portion 145c is supposed to be a linear one in order to connect two diagonally adjacent counter electrode portions 145u together. However, the present invention is in no way limited to that specific preferred embodiment. Alternatively, each connecting portion 145c may also have multiple linear portions that run in the row direction and in the column direction as shown in FIG. 13.

### Embodiment 4

In the liquid crystal display devices 100A and 100B described above, a portion of the counter electrode 144 that is provided for one row of pixel electrodes 124 is split into two linear counter electrodes 145a and 145b. However, this is only an example of the present invention. If necessary, each portion of the counter electrode 144 provided for one row of pixel electrodes 124 may be divided into three or more linear counter electrodes.

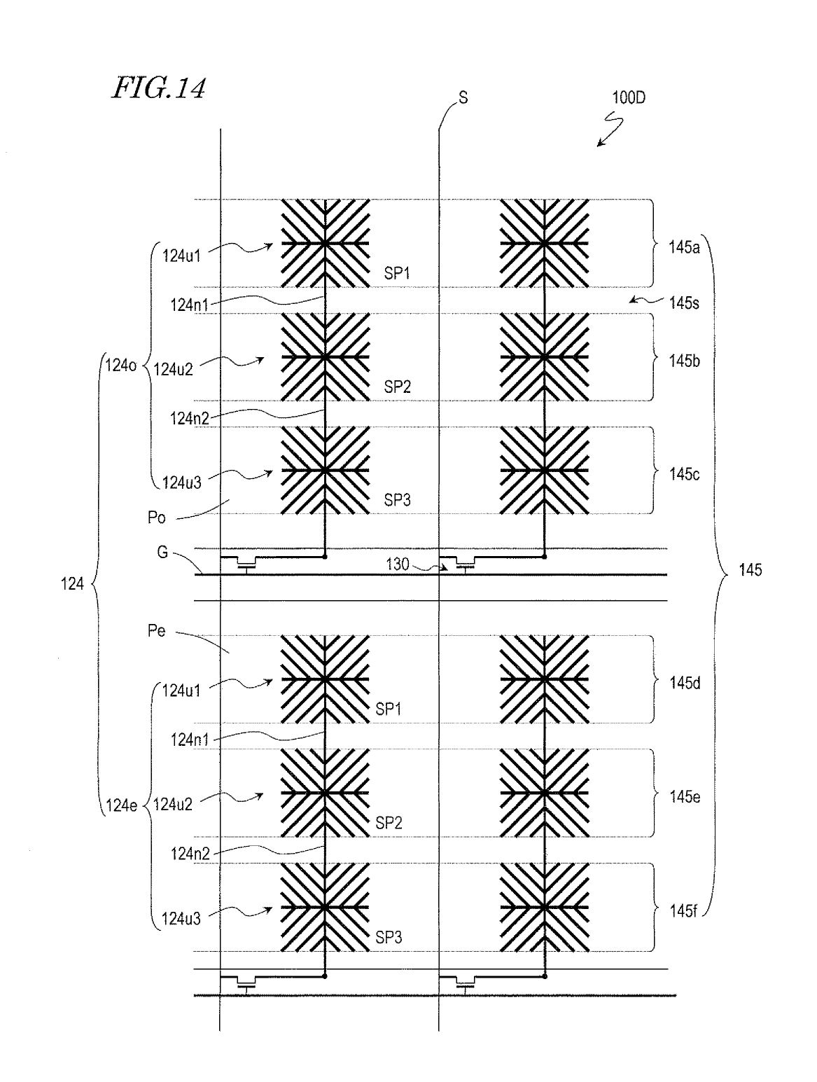

Hereinafter, a fourth preferred embodiment of a liquid crystal display device according to the present invention will be described with reference to FIG. 14. The liquid crystal display device 100D of this preferred embodiment has the same configuration as the liquid crystal display device 100A except the structure of the counter electrode 144 and the voltages applied, and description of their common features will be omitted herein to avoid redundancies.

In the liquid crystal display device 100D of this preferred embodiment, each pixel electrode 124 includes three unit portions 124u1, 124u2 and 124u3, and two linking portions 124n1 and 124n2 that connect those unit portions 124u1, 124u2 and 124u3 together. Also, a portion of the counter electrode 144 provided for one row of pixel electrodes 124 is divided into three or more linear counter electrodes 145. Any two adjacent linear counter electrodes 145 are electrically independent of each other, and mutually different counter electrode signals are applied to those counter electrodes. Each linear counter electrode 145 has a width of 45 μm and each slit 145s has a width of 5 μm.

In the following description, a pixel electrode 124 on an odd-numbered row will be identified herein by the reference numeral 124o and a pixel electrode 124 on an even-numbered row will be identified herein by the reference numeral 124e. Likewise, pixels on an odd-numbered row that are defined by the pixel electrodes 124o will be identified herein by Po and pixels on an even-numbered row that are defined by the pixel electrodes 124e will be identified herein by Pe.

Also, linear counter electrodes 145 that are respectively arranged over the unit portions 124u1, 124u2 and 124u3 of each pixel electrode 124o will be identified herein by the reference numerals 145a, 145b and 145c, respectively. On the other hand, linear counter electrodes 145 that are respectively arranged over the unit portions 124u1, 124u2 and 124u3 of each pixel electrode 124e will be identified herein by the reference numerals 145d, 145e and 145f, respectively. Each pixel P includes three subpixels SP1, SP2 and SP3. Those subpixels SP1, SP2 and SP3 of each pixel Po are defined by respective superimpositions of the linear counter electrodes 145a to 145c over the unit portions 124u1 through 124u3 of their associated pixel electrode 124o. On the other hand, those subpixels SP1, SP2 and SP3 of each pixel Pe are defined by respective superimpositions of the linear counter electrodes 145d to 145f over the unit portions 124u1 through 124u3 of their associated pixel electrode 124e. In this manner, in the liquid crystal display device 100D, the unit portions 124u1 through 124u3 of the pixel electrode 124o and the unit portions 124u1 through 124u3 of the pixel electrode 124e function as respective subpixel electrodes.

The counter electrode signals supplied to the linear counter electrodes 145a, 145c, 145d and 145f are equivalent to each other, while the counter electrode signals supplied to the linear counter electrodes 145b and 145e are also equivalent to each other. In the following description, the former group of counter electrode signals supplied to the linear counter electrodes 145a, 145c, 145d and 145f will be collectively referred to herein as a “first counter electrode signal”, and the latter group of counter electrode signals supplied to the linear counter electrodes 145b and 145e will be collectively referred to herein as a “second counter electrode signal”.

Among the subpixels SP1 through SP3 of the pixels Po and Pe, the subpixels SP1 and SP3 of the pixel Po and the subpixels SP1 and SP3 of the pixel Pe are associated with the first counter electrode signal, while the respective subpixels SP2 of the pixels Po and Pe are associated with the second counter electrode signal. That is to say, the area ratio of those subpixels associated with the first counter electrode signal to those subpixels associated with the second counter electrode signal is two to one.

It should be noted that the magnitudes of variations in respective potentials of the first and second counter electrode signals with respect to the reference potential of the counter electrode are different from each other. The area ratio of the subpixels associated with the first counter electrode signal to the subpixels associated with the second counter electrode signal is two to one as described above. That is why if the potential of the first counter electrode signal has varied by +0.5 V with respect to the reference potential of the counter electrode, that of the second counter electrode signal may have varied by −1 V with respect to the reference potential of the counter electrode. As can be seen from the foregoing description with reference to FIG. 4, the average of the respective transmittances of the pixels Po and Pe associated with the first and second counter electrode signals, of which the potentials have been varied by +0.5 V and −1 V, respectively, with respect to the reference potential of the counter electrode, is substantially equal to the transmittance of a pixel associated with the reference potential of the counter electrode.

Now, let us compare the subpixel SP1 associated with the first counter electrode signal to the subpixel SP2 associated with the second counter electrode signal. The amplitude of the voltage on the source bus line is equal to or smaller than that of the reference potential at the counter electrode. And the absolute value of the potential of the first counter electrode signal is greater than that of the potential of the second counter electrode signal. That is why even if the pixel electrode 124 has the same potential, the voltage applied to the liquid crystal layer of the subpixel SP1 is smaller than the one applied to the liquid crystal layer of the subpixel SP2 associated with the second counter electrode signal, and the subpixel SP1 has a lower transmittance than the subpixel SP2. If a subpixel with the higher transmittance and a subpixel with the lower transmittance are referred to herein as a “bright subpixel” and a “dark subpixel”, then the subpixels SP1 and SP2 are a dark subpixel and a bright subpixel, respectively. The area ratio of the subpixels associated with the first counter electrode signal to those associated with the second counter electrode signal is two to one, and therefore, the area ratio of the bright subpixels to the dark subpixels is one to two. If the total area of the dark subpixels is larger than that of the bright subpixels in this manner, the viewing angle characteristic can be improved at low to intermediate grayscales.

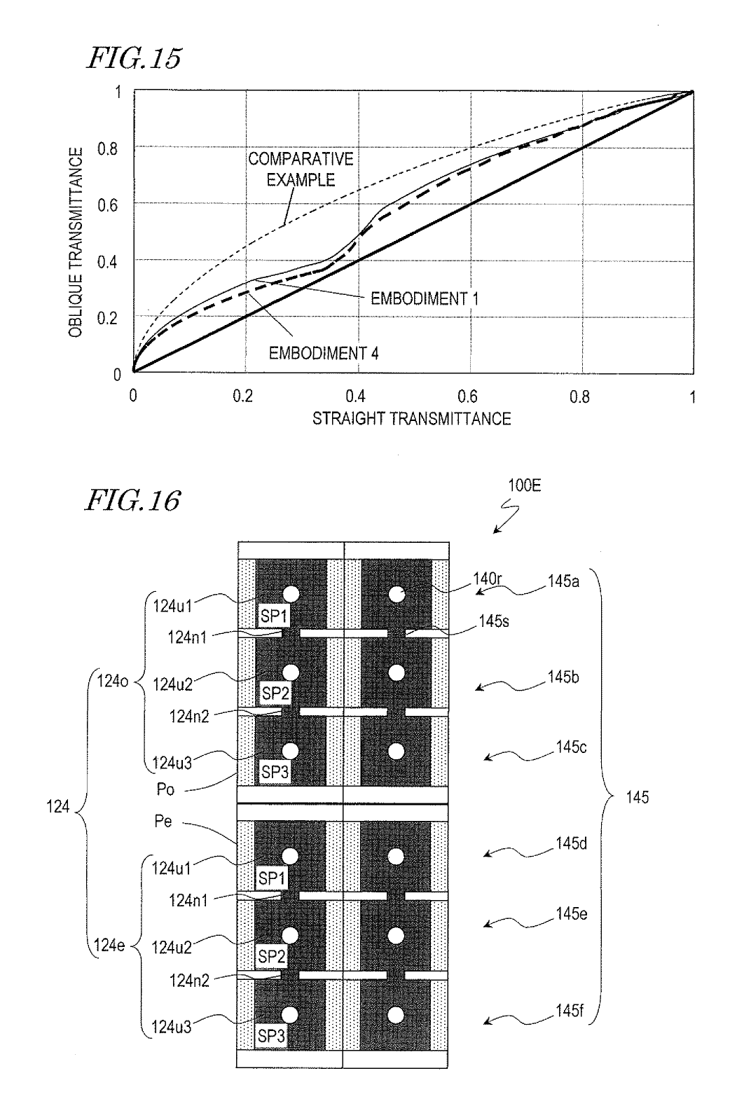

Hereinafter, it will be described with reference to FIG. 15 how the viewing angle characteristic changes as the potential at the counter electrode varies. In FIG. 15, the abscissa represents the straight transmittance and the ordinate represents the oblique transmittance. That is to say, FIG. 15 shows the viewing angle characteristic. For your reference, FIG. 15 also shows the viewing angle characteristics of a liquid crystal display device representing a comparative example and the liquid crystal display device 100A.

The liquid crystal display device 100D, in which the total area of the bright subpixels is different from that of the dark subpixels, exhibits a different viewing angle characteristic from the liquid crystal display device 100A. As can be seen from FIG. 15, the viewing angle characteristic of this liquid crystal display device 100D has improved compared to not only the liquid crystal display device as a comparative example but also the liquid crystal display device 100A as well. Also, the combined area of the dark subpixels is greater than that of the bright subpixels. And the viewing angle characteristic can be improved particularly significantly when the straight transmittance is around 0.4.

In the preferred embodiment described above, the respective subpixels SP1 and SP3 of the pixels Po and Pe that are associated with the first counter electrode signal are supposed to be bright subpixels, while the respective subpixels SP2 of the pixels Po and Pe that are associated with the second counter electrode signal are supposed to be dark subpixels. However, the present invention is in no way limited to that specific preferred embodiment. Conversely, those subpixels associated with the first counter electrode signal may be dark subpixels and those subpixels associated with the second counter electrode signal may be bright subpixels. In that case, the area ratio of the bright subpixels to the dark subpixels becomes two to one. If the total area of the dark subpixels is smaller than that of the bright subpixels in this manner, the viewing angle characteristic can be improved at intermediate to high grayscales, and can be improved particularly significantly when the straight transmittance is around 0.6.

Alternatively, the brightness of the subpixels may also be inverted on a frame-by-frame basis. For example, if subpixels associated with the first and second counter electrode signals in an N^{th} frame are a bright subpixel and a dark subpixel, then subpixels associated with the first and second counter electrode signals in the next (N+1)^{th} frame may be a dark subpixel and a bright subpixel, respectively.

Furthermore, in the foregoing description of this fourth preferred embodiment, the linear counter electrode 145c that is arranged over the unit portion 124u3 of each pixel electrode 124o is supposed to be separated from the linear counter electrode 145d that is arranged over the unit portion 124u1 of each pixel electrode 124e. However, the present invention is in no way limited to that specific preferred embodiment. Alternatively, those linear counter electrodes 145c and 145d that are laid over the respective unit portions 124u3 and 124u1 of the pixel electrodes 124o and 124e may be continuous with each other and may form integral parts of the same counter electrode.

### Embodiment 5

In the liquid crystal display device 100D described above, each pixel electrode 124 is supposed to have fishbone structure. However, this is just an example of the present invention. Hereinafter, yet another preferred embodiment of a liquid crystal display device according to the present invention will be described with reference to FIG. 16, which is a schematic plan view of a liquid crystal display device 100E as a fifth preferred embodiment of the present invention. The liquid crystal display device 100E of this preferred embodiment has the same configuration as its counterpart of the fourth preferred embodiment except that this liquid crystal display device 100E operates in the CPA mode. Thus, description of their common features will be omitted herein to avoid redundancies.

Each pixel electrode 124 includes three unit portions 124u1, 124u2 and 124u3 and two linking portions 124n1 and 124n2 that connect the unit portions 124u1, 124u2 and 124u3 together. The unit portions 124u1, 124u2 and 124u3 have a highly symmetric shape (e.g., rectangular in this example). These pixels may have measurements of 66 μm×198 μm, for example. And each display area unit, consisting of R, G and B pixels that are arranged side by side in the row direction, has an aspect ratio of almost one to one.

In the liquid crystal display device 100E of this preferred embodiment, the counter electrode 144 has a number of divided linear counter electrodes 145. Specifically, three or more divided linear counter electrodes 145 are provided for each pixel electrode 124. A slit 145s has been cut between two adjacent linear counter electrodes 145. The slit has a width of 5 μm. Any two adjacent linear counter electrodes 145 are electrically independent of each other and two different counter electrode signals are applied to them. In addition, circular openings 140r have also been cut through the surface of the counter substrate 140 so as to contact with the liquid crystal layer 160 right over or under the respective centers of the unit portions 124u1, 124u2 and 124u3 of the pixel electrode 124.

In this example, the three linear counter electrodes 145 that are respectively arranged over the unit portions 124u1, 124u2 and 124u3 of one pixel electrode 124o will be identified herein by the reference numerals 145a, 145b and 145c, respectively. On the other hand, the three linear counter electrodes 145 that are respectively arranged over the unit portions 124u1, 124u2 and 124u3 of one pixel electrode 124e will be identified herein by the reference numerals 145d, 145e and 145f, respectively. Each pixel P has three subpixels SP1, SP2 and SP3. Specifically, the subpixels SP1, SP2 and SP3 of the pixel Po are defined by the superimpositions of the linear counter electrodes 145a, 145b and 145c over their associated unit portions 124u1, 124u2 and 124u3 of the pixel electrode 124o. On the other hand, the subpixels SP1, SP2 and SP3 of the pixel Pe are defined by the superimpositions of the linear counter electrodes 145d, 145e and 145f over their associated unit portions 124u1, 124u2 and 124u3 of the pixel electrode 124e.

A first counter electrode signal is applied to the linear counter electrodes 145a, 145c, 145d and 145f, while a second counter electrode signal, which is different from the first counter electrode signal, is applied to the linear counter electrodes 145b and 145e. In this case, the V-T characteristic of the respective subpixels SP1 and SP3 of the pixels Po and Pe that are associated with the first counter electrode signal is different from that of the respective subpixels SP2 of the pixels Po and Pe that are associated with the second counter electrode signal. As a result, the V-T characteristic of the overall pixel P becomes the average of the V-T characteristics of these subpixels SP1 to SP3. Thus, in this liquid crystal display device 100E, as the counter electrode signals have mutually different potentials, the subpixels have different transmittances, and therefore, the whitening phenomenon can be reduced.

### Embodiment 6

In the liquid crystal display devices 100D and 100E described above, the ratio of the combined area of subpixels associated with the first counter electrode signal to the area of a subpixel associated with the second counter electrode signal is the same in two pixels on two adjacent rows. However, the present invention is in no way limited to that specific preferred embodiment. Alternatively, the ratio of the area of the subpixels associated with the first counter electrode signal to that of the subpixels associated with the second counter electrode signal in one of two pixels on two adjacent rows may be different from the area ratio in the other pixel on the other row.

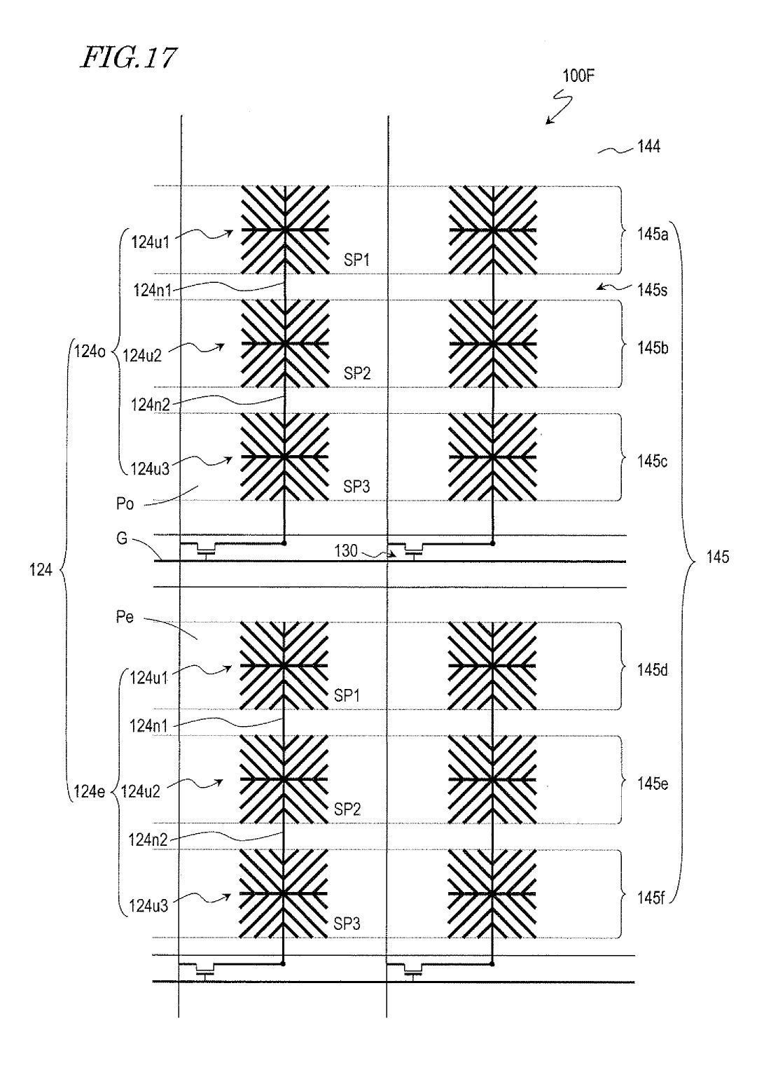

Hereinafter, a seventh preferred embodiment of a liquid crystal display device according to the present invention will be described with reference to FIG. 17. In the liquid crystal display device 100F of this preferred embodiment, the counter electrode 144 includes multiple divided linear counter electrodes 145 and three or more divided linear counter electrodes 145 are provided for one row of pixel electrodes 124. Any two adjacent linear counter electrodes 145 are electrically independent of each other, and mutually different counter electrode signals are applied to those counter electrodes. Each linear counter electrode 145 has a width of 45 μm and each slit 145s has a width of 5 μm.

In this example, the three linear counter electrodes 145 that are respectively arranged over the unit portions 124u1, 124u2 and 124u3 of one pixel electrode 124o will be identified herein by the reference numerals 145a, 145b and 145c, respectively. On the other hand, the three linear counter electrodes 145 that are respectively arranged over the unit portions 124u1, 124u2 and 124u3 of one pixel electrode 124e will be identified herein by the reference numerals 145d, 145e and 145f, respectively. Each pixel P has three subpixels SP1, SP2 and SP3. Specifically, the subpixels SP1, SP2 and SP3 of the pixel Po are defined by the superimpositions of the linear counter electrodes 145a, 145b and 145c over their associated unit portions 124u1, 124u2 and 124u3 of the pixel electrode 124o. On the other hand, the subpixels SP1, SP2 and SP3 of the pixel Pe are defined by the superimpositions of the linear counter electrodes 145d, 145e and 145f over their associated unit portions 124u1, 124u2 and 124u3 of the pixel electrode 124e.

The counter electrode signals supplied to the linear counter electrodes 145a, 145c and 145e are equivalent to each other, while the counter electrode signals supplied to the linear counter electrodes 145b, 145d and 145f are also equivalent to each other. In the following description, the former group of counter electrode signals supplied to the linear counter electrodes 145a, 145c and 145e will be collectively referred to herein as a “first counter electrode signal”, and the latter group of counter electrode signals supplied to the linear counter electrodes 145b, 145d and 145f will be collectively referred to herein as a “second counter electrode signal”.

Among the subpixels SP1 through SP3 of the pixels Po and Pe, the subpixels SP1 and SP3 of the pixel Po and the subpixel SP2 of the pixel Pe are associated with the first counter electrode signal, while the subpixel SP2 of the pixel Po and the subpixels SP1 and SP3 of the pixel Pe are associated with the second counter electrode signal. That is to say, the area ratio of those subpixels associated with the first counter electrode signal to those subpixels associated with the second counter electrode signal is one to one on the entire screen.

Now, let us compare the subpixel SP1 of the pixel Po associated with the first counter electrode signal to the subpixel SP2 of the pixel Po associated with the second counter electrode signal. The amplitude of the voltage on the source bus line is equal to or smaller than that of the reference potential at the counter electrode. And the absolute value of the potential of the first counter electrode signal is greater than that of the potential of the second counter electrode signal. That is why the voltage applied to the liquid crystal layer of the subpixel SP1 associated with the first counter electrode signal is greater than the one applied to the liquid crystal layer of the subpixel SP2 associated with the second counter electrode signal. And even if the pixel electrode 124 has the same potential, the subpixel SP1 of the pixel Po has a higher transmittance than the subpixel SP2 of the pixel Po. Thus, the subpixels SP1 and SP2 of the pixel Po are a bright subpixel and a dark subpixel, respectively.

Hereinafter, it will be described with reference to FIG. 18 how the viewing angle characteristic changes as the potential at the counter electrode varies. In FIG. 18, the abscissa represents the straight transmittance and the ordinate represents the oblique transmittance. That is to say, FIG. 18 shows the viewing angle characteristic. For your reference, FIG. 18 also shows the viewing angle characteristic of a liquid crystal display device representing a comparative example and those of the liquid crystal display devices 100A and 100D.

The liquid crystal display device 100F, in which the subpixels SP1 to SP3 have smaller areas, exhibits a different viewing angle characteristic from the liquid crystal display device 100A. As can be seen from FIG. 18, the viewing angle characteristic of this liquid crystal display device 100F has improved compared to not only the liquid crystal display device as a comparative example but also the liquid crystal display device 100A as well.

The viewing angle characteristic of this liquid crystal display device 100F is different from that of the liquid crystal display device 100D, too. As can be seen from FIG. 18, the viewing angle characteristic of the liquid crystal display device 100F has improved compared to that of the liquid crystal display device 100D.

In the preferred embodiment described above, the subpixels SP1 and SP3 of the pixel Po and the subpixel SP2 of the pixel Pe, which are associated with the first counter electrode signal, are supposed to be bright subpixels, while the subpixel SP2 of the pixel Po and the subpixels SP1 and SP3 of the pixel Pe, which are associated with the second counter electrode signal, are supposed to be dark subpixels. However, the present invention is in no way limited to that specific preferred embodiment. Conversely, those subpixels associated with the first counter electrode signal may dark subpixels and those subpixels associated with the second counter electrode signal may be bright subpixels. Still alternatively, the brightness of the subpixels may also be inverted on a frame-by-frame basis. For example, if subpixels associated with the first and second counter electrode signals in an N^{th} frame are a bright subpixel and a dark subpixel, respectively, then subpixels associated with the first and second counter electrode signals in the next (N+1)^{th} frame may be a dark subpixel and a bright subpixel, respectively.

### Embodiment 7

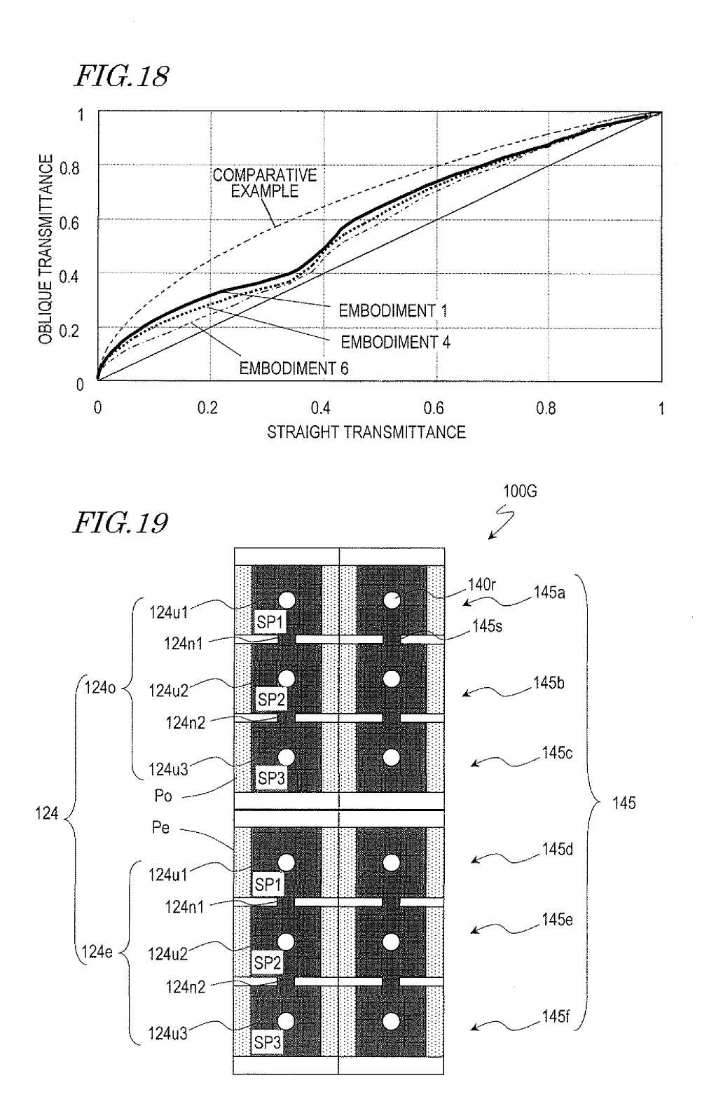

In the liquid crystal display device 100F described above, each pixel electrode 124 is supposed to have a fishbone structure. However, this is just an example of the present invention. Hereinafter, yet another preferred embodiment of a liquid crystal display device according to the present invention will be described with reference to FIG. 19, which is a schematic plan view of a liquid crystal display device 100G as a seventh preferred embodiment of the present invention. The liquid crystal display device 100G of this preferred embodiment has the same configuration as its counterpart of the sixth preferred embodiment except that this liquid crystal display device 100G operates in the CPA mode. Thus, description of their common features will be omitted herein to avoid redundancies.

Each pixel electrode 124 includes three unit portions 124u1, 124u2 and 124u3 and two linking portions 124n1 and 124n2 that connect the unit portions 124u1, 124u2 and 124u3 together. The unit portions 124u1, 124u2 and 124u3 have a highly symmetric shape (e.g., rectangular in this example).

In the liquid crystal display device 100G of this preferred embodiment, the counter electrode 144 has a number of divided linear counter electrodes 145. Any two adjacent linear counter electrodes 145 are electrically independent of each other and two different counter electrode signals are applied to them. A slit 145s has been cut between two adjacent linear counter electrodes 145. The linear counter electrodes 145 have a width of 45 μm and the slit has a width of 5 μm. In addition, openings 140r have also been cut through the surface of the counter substrate 140 so as to contact with the liquid crystal layer 160 right over or under the respective centers of the unit portions 124u1, 124u2 and 124u3 of the pixel electrode 124.

In this example, the three linear counter electrodes 145 that are respectively arranged over the unit portions 124u1, 124u2 and 124u3 of one pixel electrode 124o will be identified herein by the reference numerals 145a, 145b and 145c, respectively. On the other hand, the three linear counter electrodes 145 that are respectively arranged over the unit portions 124u1, 124u2 and 124u3 of one pixel electrode 124e will be identified herein by the reference numerals 145d, 145e and 145f, respectively. Each pixel P has three subpixels SP1, SP2 and SP3. Specifically, the subpixels SP1, SP2 and SP3 of the pixel Po are defined by the superimpositions of the linear counter electrodes 145a, 145b and 145c over their associated unit portions 124u1, 124u2 and 124u3 of the pixel electrode 124o. On the other hand, the subpixels SP1, SP2 and SP3 of the pixel Pe are defined by the superimpositions of the linear counter electrodes 145d, 145e and 145f over their associated unit portions 124u1, 124u2 and 124u3 of the pixel electrode 124e.

A first counter electrode signal is applied to the linear counter electrodes 145a, 145c and 145e, while a second counter electrode signal, which is different from the first counter electrode signal, is applied to the linear counter electrodes 145b, 145d and 145f. In this case, the V-T characteristic of the subpixels SP1 and SP3 of the pixel Pa and the subpixel SP2 of the pixel Pe, which are associated with the first counter electrode signal, is different from that of the subpixel SP2 of the pixel Po and the subpixels SP1 and SP3 of the pixel Pe, which are associated with the second counter electrode signal. As a result, the V-T characteristic of the overall pixel P becomes the average of the V-T characteristics of these subpixels SP1 to SP3. Thus, in this liquid crystal display device 100G, as the counter electrode signals have mutually different potentials, the subpixels have different transmittances, and therefore, the whitening phenomenon can be reduced.

### Embodiment 8

In the liquid crystal display devices 100A through 100G described above, any two adjacent divided counter electrodes 145 are supposed to have substantially the same shape. However, the present invention is in no way limited to those specific preferred embodiments. Optionally, two adjacent divided counter electrodes 145 may also have mutually different shapes. Furthermore, in the liquid crystal display devices 100D through 100G described above, the divided counter electrodes 145 are supposed to run straight in the row direction. But those are only examples of the present invention, too.

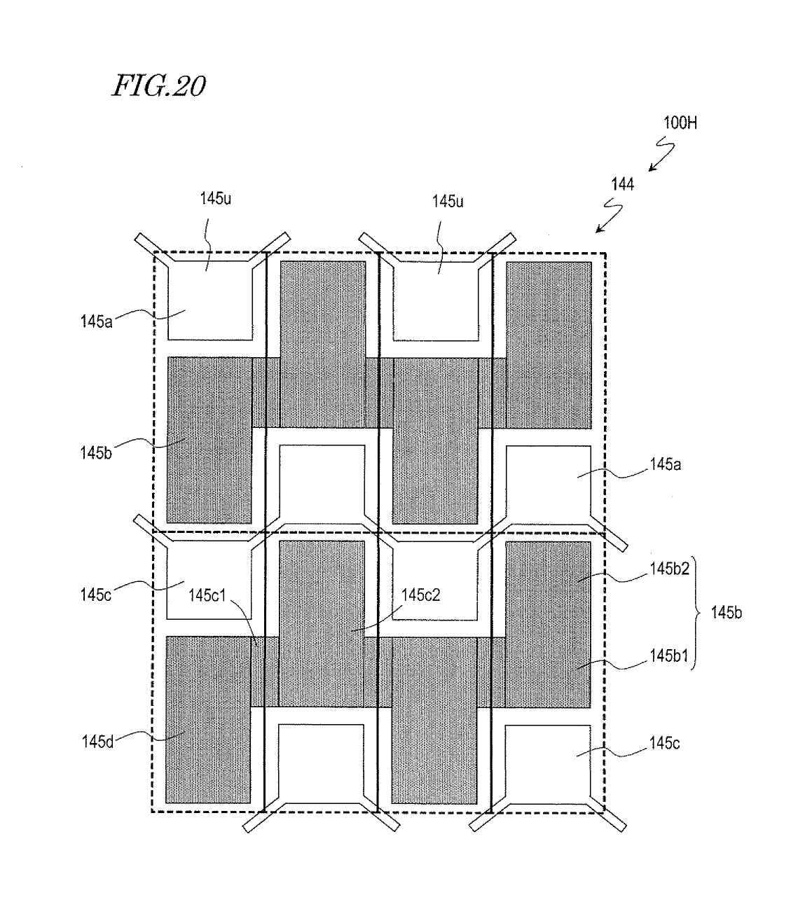

Hereinafter, an eighth preferred embodiment of a liquid crystal display device according to the present invention will be described with reference to FIG. 20. The liquid crystal display device 100H of this preferred embodiment has the same configuration as the liquid crystal display devices 100D through 100G except that its divided counter electrodes 145 have multiple different shapes. Thus, description of their common features will be omitted herein to avoid redundancies. In FIG. 20, illustrated is only a portion of the counter electrode 144 that faces a matrix of pixels that are arranged in two rows and four columns.

In FIG. 20, three divided counter electrodes 145 are identified by the reference numerals 145a, 145b and 145c, respectively. In this case, the divided counter electrode 145b is adjacent to, and has a different shape from, the divided counter electrode 145a. On the other hand, the divided counter electrode 145c has the same shape as the divided counter electrode 145a.

In the divided counter electrode 145a, each counter electrode portion 145u is not electrically connected to any of the four counter electrode portions 145u that are adjacent to it in the column and row directions, but is electrically connected to two diagonally adjacent counter electrode portions 145u with two connecting portions 145c, each of which is a linear one to connect together two diagonally adjacent counter electrode portions 145u in the shortest distance. The divided counter electrode 145a is a zigzag counter electrode that runs zigzag in the row direction and is arranged so as to be superimposed over one of the unit portions 124u of its associated pixel electrode 124 on each column.

On the other hand, the divided counter electrode 145b includes a trunk portion 145b1 that runs straight in the row direction and branch portions 145b2, each of which is extended from the trunk portion 145b so as to run in one of two opposite directions over one column and in the other direction over the next column, respectively. The divided counter electrode 145b is arranged so as to be superimposed over two of the unit portions 124u of its associated pixel electrode 124 on each column. Look at those counter electrode portions 145u that are arranged in matrix, and it can be seen that in the trunk portion 145b1, each pair of counter electrode portions 145u that are adjacent to each other in the row direction are connected together with a connecting portion 145c1 that runs in the row direction and in the branch portions 145b2, each pair of counter electrode portions 145u that are adjacent to each other in the column direction are connected together with a connecting portion 145c2 that runs in the column direction.

Hereinafter, the features of this liquid crystal display device 100H will be described in comparison with the liquid crystal display devices 100D through 100G shown in FIGS. 14, 16, 17 and 19.

First of all, look at three adjacent divided counter electrodes 145a, 145b and 145c. In the liquid crystal display devices 100D through 100G, each set of three divided counter electrodes 145a, 145b and 145c is superimposed over every unit portion 124u belonging to an associated one row of pixel electrodes 124. In the liquid crystal display device 100H, on the other hand, the unit portions 124u, located under the divided counter electrode 145b, do belong to an associated one row of pixel electrodes 124, but the unit portions 124u, located under the two other divided counter electrodes 145a and 145c, belong to not only that row of pixel electrodes 124 but also two adjacent rows of pixel electrodes 124 as well.

Next, let us consider the areas of those divided counter electrodes 145a to 145c. In the liquid crystal display devices 100D through 100G, the areas of the divided counter electrodes 145a to 145c are equal to each other. In the liquid crystal display device 100H, however, the area of each of the divided counter electrodes 145a and 145c is only a half as large as that of the divided counter electrode 145b.

Furthermore, in the liquid crystal display devices 100D through 100G, if bright and dark subpixels are defined alternately with respect to each linear divided counter electrode 145a, 145b, then those bright subpixels will be arranged in line in the column direction, so will the dark subpixels. That is why even if every pixel displayed the same grayscale, a striped bright and dark pattern could be sensed and the display quality could decline. In the liquid crystal display device 100H, on the other hand, each divided counter electrode 145a, 145 has a nonlinear shape. That is why even if bright and dark subpixels are defined alternately with respect to each divided counter electrode 145a, 145b, the decline in display quality can still be minimized.

Suppose every pixel of the liquid crystal display device 100H displays white, the unit portion 124u of every pixel electrode 124 has a potential of 0.4 V, the first counter electrode signal supplied to the divided counter electrodes 145a and 145c has a potential of 6.4 V, and the second counter electrode signal supplied to the divided counter electrode 145b has a potential of 4.4 V. In that case, a subpixel defined by one unit portion 124u of a pixel electrode 124 and its associated counter electrode portion 145u, to which the first counter electrode signal is supplied, becomes a bright subpixel. On the other hand, a subpixel defined by another unit portion 124u of the pixel electrode 124 and its associated counter electrode portion 145u, to which the second counter electrode signal is supplied, becomes a dark subpixel. Since the area of the dark subpixel is broader than that of the bright subpixel, the viewing angle characteristic can be improved at low to intermediate grayscales.

### Embodiment 9

Each of the liquid crystal display devices described above either has the fishbone structure or operates in the CPA mode. However, the present invention is in no way limited to those specific preferred embodiments.

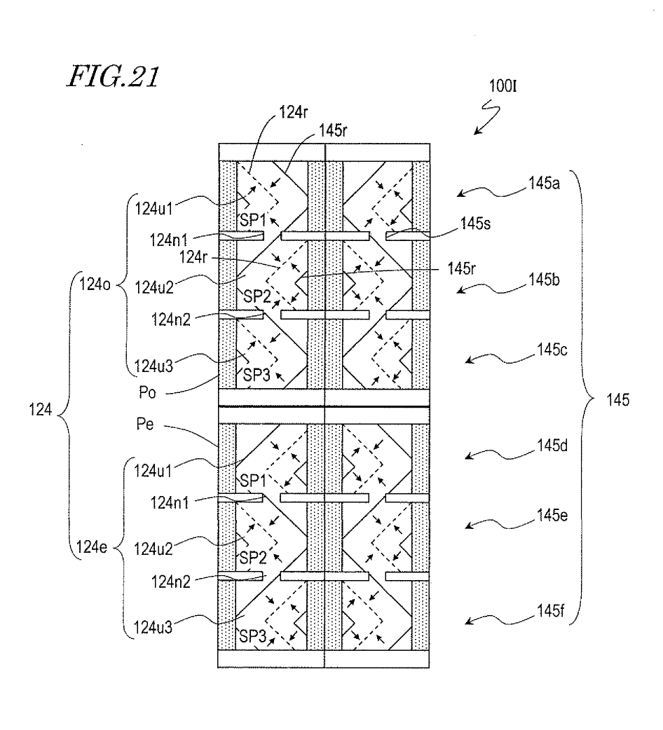

Hereinafter, a preferred embodiment of a liquid crystal display device according to the present invention will be described with reference to FIG. 21, which is a schematic plan view illustrating a liquid crystal display device 100I as a ninth preferred embodiment of the present invention. The liquid crystal display device 100I of this preferred embodiment has the same configuration as its counterparts described above except that this device 100I operates in the MVA mode. Thus, description of their common features will be omitted herein to avoid redundancies.

Each pixel electrode 124 includes three unit portions 124u1, 124u2 and 124u3 and two linking portions 124n1 and 124n2 that connect the unit portions 124u1, 124u2 and 124u3 together. The unit portions 124u1, 124u2 and 124u3 have a rectangular shape in this example.

In the liquid crystal display device 100I of this preferred embodiment, the counter electrode 144 has a number of divided linear counter electrodes 145. Any two adjacent linear counter electrodes 145 are electrically independent of each other and two different counter electrode signals are applied to them. A slit 145s has been cut between two adjacent linear counter electrodes 145.

In this example, the three linear counter electrodes 145 that are respectively arranged over the unit portions 124u1, 124u2 and 124u3 of one pixel electrode 124o will be identified herein by the reference numerals 145a, 145b and 145c, respectively. On the other hand, the three linear counter electrodes 145 that are respectively arranged over the unit portions 124u1, 124u2 and 124u3 of one pixel electrode 124e will be identified herein by the reference numerals 145d, 145e and 145f, respectively. Each pixel P has three subpixels SP1, SP2 and SP3. Specifically, the subpixels SP1, SP2 and SP3 of the pixel Po are defined by the superimpositions of the linear counter electrodes 145a, 145b and 145c over their associated unit portions 124u1, 124u2 and 124u3 of the pixel electrode 124o. On the other hand, the subpixels SP1, SP2 and SP3 of the pixel Pe are defined by the superimpositions of the linear counter electrodes 145d, 145e and 145f over their associated unit portions 124u1, 124u2 and 124u3 of the pixel electrode 124e.

The unit portions 124u1, 124u2 and 124u3 are provided with first alignment control means 124r, which extends in two directions that intersect with each other at right angles. On the other hand, the linear counter electrodes 145a through 145f are provided with second alignment control means 145r, which also extends in two directions that intersect with each other at right angles. The first alignment control means 124r is arranged parallel to the second alignment control means 145r. Each of the first and second alignment control means 124r and 145r is arranged in a belt-shape. On two sides of each of the first and second alignment control means 124r and 145r, produced are two liquid crystal domains, in one of which liquid crystal molecules 162 tilt in a particular direction and in the other of which liquid crystal molecules 162 tilt in another direction that defines an angle of 180 degrees with respect to that particular direction. As the alignment control means, any of various alignment control means (domain regulating means) as disclosed in Japanese Patent Application Laid-Open Publication No. 11-242225 may be used, for example.

In FIG. 21, slits (where there is no conductive film) are provided as the first alignment control means 124r for the unit portions 124u1, 124u2 and 124u3, and ribs (i.e., projections) are provided as the second alignment control means 145r for the linear counter electrodes 145a through 145f. These slits 124r and ribs 145r are extended so as to run in a belt shape (i.e., strip). When a potential difference is produced between one pixel electrode 124 and the counter electrode 144, each slit 124r generates an oblique electric field in a region of the liquid crystal layer 160 around the edges of the slit 124r and induces alignments of the liquid crystal molecules 162 perpendicularly to the direction in which the slit 124r runs. On the other hand, each rib 145r induces alignments of the liquid crystal molecules 162 substantially perpendicularly to its side surface, and eventually, perpendicularly to the direction in which the rib 145r runs. Each slit 124r and its associated rib 145r are arranged parallel to each other with a certain interval left between them. That is to say, a liquid crystal domain is defined between one slit 124r and its associated rib 145r that are adjacent to each other.

A first counter electrode signal is applied to the linear counter electrodes 145a, 145c and 145e, while a second counter electrode signal, which is different from the first counter electrode signal, is applied to the linear counter electrodes 145b, 145d and 145f. In this case, the V-T characteristic of the subpixels SP1 and SP3 of the pixel Po and the subpixel SP2 of the pixel Pe, which are associated with the first counter electrode signal, is different from that of the subpixel SP2 of the pixel Po and the subpixels SP1 and SP3 of the pixel Pe, which are associated with the second counter electrode signal. As a result, the V-T characteristic of the overall pixel P becomes the average of the V-T characteristics of these subpixels SP1 to SP3. Thus, in this liquid crystal display device 100I, as the counter electrode signals have mutually different potentials, the subpixels have different transmittances, and therefore, the whitening phenomenon can be reduced.

In the preferred embodiment described above, slits (where there is no conductive film) are provided as the first alignment control means 124r for the unit portions 124u1 through 124u3. However, this is just an example of the present invention. Alternatively, ribs may also be provided as the first alignment control means 124r for the unit portions 124u1 to 124u3. Also, in the preferred embodiment described above, ribs (i.e., projections) are provided as the second alignment control means 145r for the linear counter electrodes 145a through 145f. However, this is only an example of the present invention, too. Alternatively, slits may also be provided as the second alignment control means 145r for the linear counter electrodes 145a to 145f.

Optionally, the PSA technology may also be applied to this liquid crystal display device 100I. Then, the response speed can be increased and the alignments of the liquid crystal molecules 162 can be stabilized as well. The PSA technology is particularly effective if at least one of the first and second alignment control means 124r and 145r is slits.

Also, in the preferred embodiments described above, each pixel electrode 124 is supposed to include three unit portions 124u1, 124u2 and 124u3. However, the present invention is in no way limited to those specific preferred embodiments and the number of unit portions included in each pixel electrode 124 does not have to be three but may be any other number. For example, the area of the bright subpixel SP may be equal in each pixel electrode 124 to that of the dark subpixel and the pixel electrode 124 may include two unit portions. Still alternatively, the pixel electrode 124 may not be divided into multiple unit portions and may even be a single rectangular electrode, too.

Furthermore, in the preferred embodiments described above, the multiple linear counter electrodes are supposed to be electrically connected together in the frame area. However, this is just an example of the present invention. Alternatively, a driver (not shown) may supply multiple counter electrode signals to associated linear counter electrodes, too.

Furthermore, in the preferred embodiments described above, two different counter electrode signals are supposed to be supplied to those multiple linear counter electrodes. But those preferred embodiments of the present invention may also be modified so that three or more different counter electrode signals are supplied to those linear counter electrodes.

Furthermore, although each pixel is supposed to have regions with two mutually different V-T characteristics in the preferred embodiments described above, those embodiments of the present invention may be modified so that each pixel may have regions with three or more different V-T characteristics.

The entire disclosure of Japanese Patent Application No. 2008-263128, from which the present application claims priority, is hereby incorporated by reference.

### INDUSTRIAL APPLICABILITY

The present invention provides a liquid crystal display device that can minimize a decrease in the aperture ratio of the display area and that can reduce the whitening phenomenon efficiently.

### REFERENCE SIGNS LIST

100A through 100I liquid crystal display device
120 active-matrix substrate
122 insulating substrate
124 pixel electrode
126 alignment layer
140 counter substrate
142 insulating substrate
144 counter electrode
145 divided counter electrode
146 alignment layer

1. A liquid crystal display device comprising:
an active-matrix substrate including a number of pixel electrodes that are arranged in columns and rows so as to form a matrix pattern;
a counter substrate including a counter electrode; and
a vertical alignment liquid crystal layer, which is interposed between the active-matrix substrate and the counter substrate,
wherein the counter electrode includes a number of divided counter electrodes, and
wherein each said pixel electrode is associated with at least two of the divided counter electrodes that are arranged over the pixel electrode.

2. The liquid crystal display device of claim 1, wherein each said divided counter electrode runs in a row direction in which the rows are defined.

3. The liquid crystal display device of claim 1, wherein the divided counter electrodes include first and second divided counter electrodes, the second divided counter electrode being arranged adjacent to the first divided counter electrode, and
wherein first and second counter electrode signals are supplied to the first and second divided counter electrodes, respectively, the second counter electrode signal being different from the first counter electrode signal.

4. The liquid crystal display device of claim 1, wherein each said divided counter electrode runs straight in the row direction.

5. The liquid crystal display device of claim 4, wherein one row of the pixel electrodes is associated with at least two of the divided counter electrodes that are arranged over that row of pixel electrodes.

6. The liquid crystal display device of claim 1, wherein each said divided counter electrode has a portion that is extended obliquely with respect to the row direction.

7. The liquid crystal display device of claim 6, wherein at least one of the divided counter electrodes runs zigzag in the row direction.

8. The liquid crystal display device of claim 6, wherein one of any two adjacent ones of the divided counter electrodes is superimposed over a part of one particular row of the pixel electrodes, and
wherein the other one of the two adjacent divided counter electrodes is superimposed over not only another part of that particular row of pixel electrodes but also a part of another row of pixel electrodes, said another row being adjacent to that particular row.

9. The liquid crystal display device of claim 7, wherein each of the divided counter electrodes runs zigzag in the row direction.

10. The liquid crystal display device of claim 7, wherein one of any two adjacent ones of the divided counter electrodes runs zigzag in the row direction, and
wherein the other one of the two adjacent divided counter electrodes has a trunk portion that runs straight in the row direction and branch portions, which are extended from the trunk portion so as to run in two opposite directions and change the directions one column after another.

11. The liquid crystal display device of claim 1, wherein each of the pixel electrodes has multiple unit portions, and
wherein each of the divided counter electrodes is arranged over at least one of the unit portions that at least one of the pixel electrodes that form each said row has.

12. The liquid crystal display device of claim 11, wherein liquid crystal molecules in the liquid crystal layer are aligned symmetrically with respect to the center of each of the unit portions.

13. The liquid crystal display device of claim 11, wherein the surface of the counter substrate that contacts with the liquid crystal layer has openings or rivets, which are located right over the respective centers of the unit portions.

14. The liquid crystal display device of claim 11, wherein each said unit portion has a fishbone structure.

15. The liquid crystal display device of claim 14, wherein the surface of the unit portions that contacts with the liquid crystal layer has ribs or slits, and
wherein the surface of the counter substrate that contacts with the liquid crystal layer also has ribs or slits.

16. The liquid crystal display device of claim 3, wherein the area of some of the divided counter electrodes, to which the first counter electrode signal is supplied, is different from that of some other one(s) of the divided counter electrodes, to which the second counter electrode signal is supplied.

17. The liquid crystal display device of claim 3, wherein the area of some of the divided counter electrodes, to which the first counter electrode signal is supplied, is substantially equal to that of some other one(s) of the divided counter electrodes, to which the second counter electrode signal is supplied.

18. The liquid crystal display device claim 1, further comprising a first alignment sustaining layer, which is arranged between the pixel electrodes and the liquid crystal layer, and a second alignment sustaining layer, which is arranged between the counter electrode and the liquid crystal layer.

19. The liquid crystal display device of claim 1, wherein at least one of the active-matrix substrate and the counter substrate further includes an alignment layer, and
wherein when no voltage is applied to the liquid crystal layer, liquid crystal molecules tilt with respect to a normal to the principal surface of the alignment layer.
